(19) United States
(12) Patent Application Publication
(10) Pub. No.: US 2013/0254293 A1
(43) Pub. Date: Sep. 26, 2013

(54) SYSTEM AND METHODS FOR AN ON-LINE EVENT LANDER

(71) Applicant: Jason REEDY, Brentwood, CA (US)

(72) Inventor: Jason REEDY, Brentwood, CA (US)

(21) Appl. No.: 13/891,131

(22) Filed: May 9, 2013

Related U.S. Application Data
(62) Division of application No. 13/208,888, filed on Aug. 12, 2011.

(51) Int. Cl. H04L 29/08

(52) U.S. Cl. CPC H04L 67/02
USPC 709/204

(57) ABSTRACT

Systems and methods are provided for a user to create an event lander page for a recipient for delivery on-line. The system includes a graphical interface for the user to include text, photo, audio, video, and gift card and to select a future date until when the full content of the page is blocked from viewing by the recipient. The recipient will receive a notification when the page is created, but the recipient can only wait in anticipation because only limited information on the page is viewable before the future date. The notification may be posted on a recipient's social network homepage and thus generate wide publicity among the recipient's friends on the social network. The system may allow the recipient's friends to add their own greetings to the same event lander page. In one application, the event lander page may be used for on-line social greeting and gifting.

### RELATED APPLICATIONS

This application is a divisional application of commonly-owned U.S. patent Nonprovisional application Ser. No. 13/208,888 submitted 12 Aug. 2011 by Jason Reedy, from which priority is hereby claimed, and which is hereby incorporated by reference in its entirety.

### FIELD OF THE INVENTION

This invention relates generally to systems and methods of an on-line event lander that can be used to deliver greetings and gifts that can be opened only at a pre-determined future event date but can be previewed by the recipient of the greetings and gifts to create anticipation.

### BACKGROUND

Social network websites help enrich people's lives by facilitating people to express themselves, communicate with friends, and make new friends. Popular social network websites such as Facebook and Myspace allow a user to register and have his own home page where the user can post pictures and messages. The user can connect with other users and become “friends” on the social network site. Under usual settings, friends can view messages and pictures posted on each others' home pages. Friends can also post messages on each others' home pages directly or through a third-party application. A social network site may also include a News Feed feature that enables a user to see on his own home screen the new activities on his friends' home pages. Thus, if a user posts a photo on his own home page, his friends will see the post on their home pages under News Feed. If a user puts his birthday information on a social network site, it is possible that his friends on the network will get notices of his coming birthday and be reminded to send a birthday greeting. Thus, it is common for a user to get posts on his home page such as “Happy birthday, have a great day!” “Happy Birthday! Have a fun day and a great year ahead!” However, social network sites generally do not offer functions for users to send greeting cards or gifts.

Electronic greeting cards are available through websites such as www.egreetings.com or www.123greetings.com. However, the e-greeting card websites usually are not well integrated with the social network sites and are not adapted for multiple people to sign the same card, like what would happen in an office where coworkers would sign one birthday card for the birthday of a coworker. Moreover, usually it is impossible to send a personal photo, a personal video, or a gift card in an electronic greeting card, and a sender is restricted to the designs that are available on an e-greeting card website.

Anticipation of a surprise gift is part of the excitement of receiving a gift. For example, children are excited to see Christmas gift boxes under a Christmas tree, but they are not supposed to open the gift boxes until Christmas day. The anticipation of a gift and guessing of what the gift is will keep a child excited for several days leading to the opening of the gift. In contrast, conventional on-line greetings or electronic gift cards can be opened right away and are without the excitement of anticipation.

### SUMMARY OF THE INVENTION

It is a object of the current invention to duplicate the excitement of real-world gifting and greeting, and to multiply the excitement with the power of social network to express and connect. An object of the current invention is to offer an electronic method and system for multiple people to contribute to a common gift and greetings. A real-world analogy would be multiple friends contributing to buy a group gift and sign a greeting card for a friend, for example, for a baby shower. A further object of the current invention is to combine group gifting and greeting with the power of social networking. For example, if every time when a friend contributes to a group gift, a message is posted on the recipient's home page on a social network, and the message is propagated on the recipient's friends' home pages, the group gift will be widely publicized among the friends. A yet further object of the current invention is to create anticipation in the recipient. For example, the group gift and greeting may be locked until a certain date, e.g. a birthday, yet the recipient will receive multiple notices on his social network home page that a new greeting or a new gift is received. The recipient cannot help but expect in excitement as to what greetings or gifts he/she has received.

According to one embodiment, an event lander system comprises a registration module for a user to input user information and register with said event lander system as a registered user; an editing module having a template and a user input interface for a registered user to select a trigger event, and to create an event lander page with user contents, said editing module is enabled such that said user contents comprises one or more items selected from the group consisting of text, image, audio, video, hyperlink, and gift card, said registered user is identified to said event lander page as an initiator, part of said user contents is designated as initiator contents, said initiator contents may only be edited by said initiator before said trigger event occurs. In certain aspects of the embodiment the event lander page may include initiator content that comprises a title and page layout, wherein said initiator content can be viewed by participant and recipient before a trigger event; at least part of said user contents may optionally be designated by said initiator as confidential contents that can only be viewed by said initiator before said event date; and a communications module for sending a notification to one or more recipients, said notification comprising an address of said event lander page; wherein before said trigger event occurs, viewing of said confidential contents is restricted to the one who created it; wherein after said trigger event occurs, viewing of said confidential contents is not restricted to the one who created it. In other various aspects the embodiment may include a feature wherein said trigger event comprises a release date. In yet other aspects of the embodiment, said event lander editing module is adapted to further allow a registered user other than said initiator to edit said user contents of said event lander page, wherein said registered user other than said initiator is identified to said event lander page as a participant, user contents created by said participant is identified as participant contents and is identified to said participant, said participant contents may only be edited by said participant, at least part of said participant contents may be designated by said participant as confidential contents. In yet another aspect of the embodiment, the event lander editing module is adapted to allow said initiator to designate a recipient, wherein said recipient is given exclusive right to view at least part of said user contents including a gift card.

According to another embodiment, a method for providing an event lander system comprises the following steps: registering a user in a database and maintaining user information in said database; providing an editing module having a template and a user interface for a registered user to select a trigger event, and to create an event lander page with user contents, said editing module is enabled such that said user contents comprises one or more items selected from the group consisting of a text message, an image, an audio, a video, a hyperlink, and a gift card, said registered user is identified to said event lander page as an initiator, part of said user contents is designated as initiator contents, said initiator contents may only be edited by said initiator, at least part of said user contents may optionally be designated by said initiator as confidential contents; and sending a first notification to one or more recipients, said notification comprising an identifier of said event lander page; wherein before said trigger event occurs, viewing of said confidential contents is restricted to the one who created it; wherein after said trigger event occurs, viewing of said confidential contents is not restricted to the one who created it. In certain aspects of the embodiment, the method may further comprise steps for providing a means for a registered user other than said initiator to edit said user contents of said event lander page, wherein said registered user other than said initiator is identified to said event lander page as a participant, user contents created by said participant is identified as participant contents and is identified to said participant, said participant contents may only be edited by said participant, at least part of said participant contents may be designated by said participant as confidential contents. In other various aspects of the embodiment, the method further comprises providing a means for said initiator to designate a recipient in relation to said event lander pager, wherein said done is given exclusive right to view part of said user content designated as recipient exclusive contents, said recipient exclusive contents including the amount of said gift card. In yet another aspect of the embodiment, the method further comprises integrating the event lander system with one or more social networking applications.

According to another embodiment, an event lander comprises an event certain that will happen in the future, a subject certain associated with the event certain, a website that allows a sponsor and at least one gift giver to add messages, gift cards, photos, videos, music, and other digital media to be stored therein, said media locked such that the gift givers and recipient may not access the media stored therein and that at the appointed time, the recipient may access the stored media and redeem one or more gifts, and an event lander page view comprising public content and private content. In another aspect of the embodiment, the event lander further comprises integrating with one or more social networking applications. In another aspect of the embodiment, the event lander further comprises at least one gift giver that is a registered user that may be able to view the event lander page and may be able to add user content. In other certain aspects, the embodiment may include at least one gift giver that is an unregistered user that may be able to view the event lander page but may not be able to add user content. In various aspects, the event lander may also include a feature wherein the registered users may be selected from the group consisting of initiator, participant, and recipient. In yet another aspect of the embodiment, the event lander website is associated with one or more Facebook® pages. In another aspect of the embodiment, the event lander further comprises a title, a greeting, an event counter comprising a timer countdown, said timer countdown including one or more time categories of days, hours, minutes, and seconds until the appointed time to open gifts, an add gift button, a birthday cake comprising greetings and gifts near the base of the birthday cake, a gift counter, and a gift greeting wall comprising one or more individual gifter blocks. In another aspect of the embodiment, the event lander further comprises a link to one or more large social network websites that has one or more registered members, a link button that is displayed on a member's home page at a predetermined time near a member's birthday, one or more friends that are directed to the event lander where birthday greetings and gift cards can be entered when a friend of the member clicks on the link. In yet another aspect of the embodiment, the event lander further includes an editing module including a template and a user input interface, wherein said editing module is designed to facilitate a registered user to create an event lander page with user contents, said editing module is enabled such that said registered user can edit general content including page layout, graphic design, common greeting, said general content can be viewed by anyone who accesses said event lander at any time; said registered user can edit private content comprising one or more items selected from the group consisting of text, image, audio, video, hyperlink, and gift card; said registered user can edit confidential content comprising one or more items selected from the group consisting of text, image, audio, video, hyperlink, and gift card; a database for storing said user contents, wherein said user contents are identified to said registered user and said recipient such that viewing of said general content is available to anyone who has access to said event lander, viewing of said private content is restricted to said registered user before said predetermined event occurs, viewing of said confidential content is limited said registered user before said pre-determined event occurs, and viewing of said confidential event is limited said registered user and said recipient after said predetermined event occurs; and a database server for delivering said event lander page such that said event lander page is associated with a web browser and one or more applications. In other certain aspects, the event lander further includes an event lander page that may be created for a predetermined event for a predetermined recipient, and more than one registered users may contribute to the same event lander; and a portion of event lander system general content wherein after a first registered user has created an event lander page for said predetermined event for a predetermined recipient, said general content is selected from the group consisting of the layout, theme, generic greeting, counter, and display of contributors at the bottom of page, wherein said portion of event lander system general content is shared with later registered users who contribute additional content to said event lander page. In other various aspects, the event lander may include more than one event lander page may be for a predetermined event for a predetermined recipient, and more than one registered users may contribute to the same event lander and after a first registered user has created an event lander page for said predetermined event for a pre-determined recipient, some event lander system general content is selected from the group consisting of the layout, theme, generic greeting, counter, and display of contributors at the bottom of page, is shared with later registered users who contribute contents to said event lander page.

In another embodiment, a computer implemented method including computer-usable readable storage medium having computer-readable program code embodied therein for causing a computer system to perform a method of providing a social network based peer computing system including the following steps: registering a user in a database and maintaining user information in the database; providing an editing module having a template and a user interface for a registered user to select a trigger event, and to create an event lander page with user contents, the editing module is enabled such that the user contents comprises one or more items selected from the group consisting of a text message, an image, an audio, a video, a hyperlink, and a gift card. The registered user who created the event lander page is identified to the event lander page as an initiator, part of the user contents is designated as initiator contents, and the initiator contents may only be edited by the initiator. At least part of the user contents may optionally be designated by the initiator as confidential contents. A first notification will be sent to one or more recipients, the notification comprising an identifier of the event lander page, such as a web address. Before the trigger event occurs, viewing of the confidential contents is restricted to the one who created it. After the trigger event occurs, viewing of the confidential contents is no longer restricted to the one who created it.

In another embodiment, a computer-implemented platform including computer-usable readable storage medium having computer-readable program code embodied therein for causing a computer system to perform steps to allow a first user to establish a relationship with a second user in a social network based peer computing system comprises a custom computer platform, an editing module including a template, and a user input interface, wherein the editing module is designed to facilitate a registered user to create an event lander page with user contents, the editing module is enabled such that the registered user can edit general content including page layout, graphic design, common greeting like that commonly printed on a birthday card. The general content can be viewed by anyone who accesses the event lander at any time. The registered user can edit private content comprising one or more items selected from the group consisting of text, image, audio, video, hyperlink, and gift card. The registered user can edit confidential content comprising one or more items selected from the group consisting of text, image, audio, video, hyperlink, and gift card. There is a database for storing the user contents, wherein the user contents are identified to the registered user and the recipient such that viewing of the general content is available to anyone who has access to the event lander, viewing of the private content is restricted to the registered user before the predetermined event occurs, viewing of the confidential content is limited to the registered user before the predetermined event occurs, and viewing of the confidential event is limited the registered user and the recipient after the predetermined event occurs. There is also a database server for delivering the event lander page such that the event lander page is properly displayed to a viewer.

In another embodiment, a computer system for providing a method of social gifting comprises a computer that is coupled to a digital communications network by a communications link to a network of computers; an electronic digital memory in the computer; one or more sequences of computer program instructions stored in the electronic digital memory which, when executed, cause the computer system to perform the steps of registering a user in a database and maintaining user information in the database; providing an editing module having a template and a user interface for a registered user to select a trigger event, and to create an event lander page with user contents. The editing module is enabled such that the user contents comprises one or more items selected from the group consisting of a text message, an image, an audio, a video, a hyperlink, and a gift card. The registered user who created the event lander page is identified to the event lander page as an initiator, part of the user contents is designated as initiator contents, the initiator contents may only be edited by the initiator, and at least part of the user contents may optionally be designated by the initiator as confidential contents. The computer system will further send a first notification to one or more recipients, the notification comprising an identifier of the event lander page. Before the trigger event occurs, viewing of the confidential contents is restricted to the one who created it. After the trigger event occurs, viewing of the confidential contents is not restricted to the one who created it.

In another embodiment, a computer readable medium for providing a method of social gifting, comprises program code for registering a user in a database and maintaining user information in the database; program code for providing an editing module having a template and a user interface for a registered user to select a trigger event, and to create an event lander page with user contents, the editing module is enabled such that the user contents comprises one or more items selected from the group consisting of a text message, an image, an audio, a video, a hyperlink, and a gift card, the registered user is identified to the event lander page as an initiator, part of the user contents is designated as initiator contents, the initiator contents may only be edited by the initiator, at least part of the user contents may optionally be designated by the initiator as confidential contents; and program code for sending a first notification to one or more recipients, the notification comprising an identifier of the event lander page; wherein before the trigger event occurs, viewing of the confidential contents is restricted to the one who created it; wherein after the trigger event occurs, viewing of the confidential contents is not restricted to the one who created it.

In another embodiment, one or more processor readable storage devices having processor readable code embodied on at least one processor readable storage devices, the processor readable code for programming at least one processor to perform a method of social gifting, comprises steps for registering a user in a database and maintaining user information in the database; providing an editing module having a template and a user interface for a registered user to select a trigger event, and to create an event lander page with user contents, the editing module is enabled such that the user contents comprises one or more items selected from the group consisting of a text message, an image, an audio, a video, a hyperlink, and a gift card, the registered user is identified to the event lander page as an initiator, part of the user contents is designated as initiator contents, the initiator contents may only be edited by the initiator, at least part of the user contents may optionally be designated by the initiator as confidential contents; and sending a first notification to one or more recipients, the notification comprising an identifier of the event lander page; wherein before the trigger event occurs, viewing of the confidential contents is restricted to the one who created it; wherein after the trigger event occurs, viewing of the confidential contents is not restricted to the one who created it.

In another embodiment, a computer implemented apparatus for providing a method of social gifting is an apparatus comprising a processor; an input device coupled to the processor; a memory coupled to the processor; an output device; and an execution engine including a method for providing a social gifting system comprising the steps for registering a user in a database and maintaining user information in the database; providing an editing module having a template and a user interface for a registered user to select a trigger event, and to create an event lander page with user contents, the editing module is enabled such that the user contents comprises one or more items selected from the group consisting of a text message, an image, an audio, a video, a hyperlink, and a gift card, the registered user is identified to the event lander page as an initiator, part of the user contents is designated as initiator contents, the initiator contents may only be edited by the initiator, at least part of the user contents may optionally be designated by the initiator as confidential contents; and sending a first notification to one or more recipients, the notification comprising an identifier of the event lander page; wherein before the trigger event occurs, viewing of the confidential contents is restricted to the one who created it; wherein after the trigger event occurs, viewing of the confidential contents is not restricted to the one who created it.

In another embodiment, a customizable application system for providing a social gifting platform, comprises a social network computer system application execution system for social gifting to implement an event lander system including a registration module for a user to input user information and register with the event lander system as a registered user; an editing module having a template and a user input interface for a registered user to select a trigger event, and to create an event lander page with user contents, the editing module is enabled such that the user contents comprises one or more items selected from the group consisting of text, image, audio, video, hyperlink, and gift card, the registered user is identified to the event lander page as an initiator, part of the user contents is designated as initiator contents, the initiator contents may only be edited by the initiator, at least part of the user contents may optionally be designated by the initiator as confidential contents; and a communications module for sending a notification to one or more recipients, the notification comprising one or more addresses of the event lander page; wherein before the trigger event occurs, viewing of the confidential contents is restricted to the one who created it; wherein after the trigger event occurs, viewing of the confidential contents is not restricted to the one who created it; a processor; an input device coupled to the processor; a memory coupled to the processor; an output device; and an execution engine including a method for providing a social gifting system comprising steps for registering a user in a database and maintaining user information in the database; providing an editing module having a template and a user interface for a registered user to select a trigger event, and to create an event lander page with user contents, the editing module is enabled such that the user contents comprises one or more items selected from the group consisting of a text message, an image, an audio, a video, a hyperlink, and a gift card, the registered user is identified to the event lander page as an initiator, part of the user contents is designated as initiator contents, the initiator contents may only be edited by the initiator, at least part of the user contents may optionally be designated by the initiator as confidential contents; and sending a first notification to one or more recipients, the notification comprising an identifier of the event lander page; wherein before the trigger event occurs, viewing of the confidential contents is restricted to the one who created it; wherein after the trigger event occurs, viewing of the confidential contents is not restricted to the one who created it.

In another embodiment, a method for providing a social gifting system, comprises steps for creating a predefined event date and an associated first greeting message to a recipient; assembling an event icon to visualize the associated subsequent greeting messages with one or more gifts from one or more gift greeting friends; displaying the event icon and one or more gifts in an event lander page view; and appending a gift greeting grid to a gift counter to aggregate one or more gift greeting friend photos.

In another aspect of the embodiment, the method for providing a social gifting system, includes the previous steps wherein the one or more gifts in an event lander page view comprise one or more gift groups, the gift groups selected from the group consisting of gift group 1/five packages in a single row, gift group 2/13×2 packages comprising thirteen packages in two rows, gift group 3/15×2 packages comprising fifteen packages in two rows, and gift group 4/4×2 packages comprising four packages in two rows. In other certain aspects of the embodiment, the social gifting system method includes steps wherein the one or more gifts may be redeemed from one or more participating vendors in one or more categories. In other various aspects of the embodiment, the method for providing a social gifting system further comprises steps for associating the one or more gifts with a related gift greeting photo through the use of a friend finder tool. In some aspects, the method includes steps wherein the event icon is a birthday cake. In other various aspects the method includes steps wherein the social gifting system is a gift registry and wherein an event announcement and a desired gift list is displayed for one or more gift greeter friends. In another aspect of the embodiment, the method further comprises steps for updating the desired gift list to reflect the selected gifts by one more gift greeter friends to display an updated inventory of desired gifts in the desired gift list. In another aspect of the embodiment, the method includes steps wherein the event announcement is associated with a news message.

In another embodiment, a computer implemented method of social gifting, comprises providing a first registered user through an interface; providing a means for the first user to create a database of one or more friends; providing an interface for the first user to select a recipient; wherein the interface comprising program code to be delivered to the initiator's digital device for displaying a select-your-friend page, the select-your-friend page allowing the initiator to select a recipient from a list displayed on the web page; wherein the interface comprising program code to be delivered to the initiator's digital device for displaying a select-your-friend page, the select-your-friend page allowing the initiator to search for a friend from a database of friends and to select a recipient from a search result list; providing an interface for the first user to select an event and a template for creating an event lander page for the event; providing an interface for the first user to create a greeting for the event to be delivered with the event lander, the greeting comprising one or more items selected from the group consisting of a message, a picture, a video, and a gift card; wherein the gift card comprises a proprietary gift card, the proprietary gift card can be redeemed by the recipient to buy vendor gift cards; providing a means for delivering the event lander page through a web browser over a network, the event lander page displaying the greeting, part of the content of the greeting being locked until a release date, the event lander page comprising an add-gift button; providing a means for the first user to designate part of his greeting as private content that cannot be displayed on the event lander page after the release date; wherein the add-gift button in blocked to the recipient such that the recipient cannot add gift to itself; sending a message to the recipient, the message comprising a link to the event lander page; wherein the message is posted on the recipient's social network webpage wall; locking the event lander page; sending a message to one or more friends of the recipient; unlocking the event lander page after the release date so that the recipient can view the full content of the greeting; providing a mechanism for the recipient to restrict the viewing of part of the greeting to the recipient only; sending the greeting to the recipient via internet for displaying on the recipient's electronic device, after the release date; unlocking the event lander page after the release date and enabling the recipient to redeem gift cards sent through the event lander page; and enabling the recipient to combine gift cards.

In another aspect of the embodiment, the computer implemented method of social gifting further comprises steps for providing a registered second user through an interface; providing a means for the second user to select the event lander page and to add a second greeting on the event lander page, the greeting comprising one or more items selected from the group consisting of a message, a picture, a video, and a gift card; wherein the gift card comprises a proprietary gift card, the proprietary gift card can be redeemed by the recipient to buy vendor gift cards, wherein the second greeting comprises participant content associated with one or more privacy privilege status identifiers, wherein the privacy privilege status identifiers are selected from the group consisting of public participant content, confidential content, and optionally private content; associating the second greeting with the second user, locking the second greeting so that the confidential content and the private content of the second greeting can only be viewed by the second user; sending a second message to the recipient, the message comprising a link to the event lander page; wherein the message may be posted on the recipient's Facebook wall to notify the recipient that the second user has posted a greeting on the event lander page; and sending a message to one or more friends of the recipient.

In another embodiment, an event lander editing page view for selecting an event comprises a title; an editing module including a field for searching for a friend comprising an input box for inputting search terms and a search button; a list of available friends with available upcoming events, the upcoming events comprising birthdays, anniversaries, and weddings; a select event button displayed next to each available upcoming event, the select event button comprising a link to a page view for editing or creating an event lander page for the upcoming event, the text label of the select event button changing depending on whether an event lander page is already created; wherein before an event lander page is created, the label of the button may be “Create Event”, once an event lander page is created, the label of the select event button may become “Edit Event”, clicking the button will lead to a page for editing the event lander page view; and a send gift button that is displayed next to each available upcoming event, the send gift button being blocked before the event lander page is created, once the event lander page is created and the send gift button is unlocked, pressing the send gift button by a user causing the event lander page to be available for viewing over a network and causing a message to be sent to the recipient wherein the recipient is the friend for whom the event lander page was created, the message comprising a link to the event lander page.

In another embodiment, a method for providing an event lander editing page view for selecting an event, comprises steps for associating a title; searching for a friend comprising an input box for inputting search terms and a search button; identifying a list of available friends with available upcoming events, the upcoming events comprising birthdays, anniversaries, and weddings; if there is no such upcoming event, there is no list. The list may be organized chronologically. For each available friend with an available upcoming event, the date, the friend's name, and a description of the event are displayed. Additional steps include selecting an event to provide a link to a page view for editing or creating an event lander page for the upcoming event, the text label of the select event button changing depending on whether an event lander page is already created; wherein before an event lander page is created, the label of the button may be “Create Event”, once an event lander page is created, the label of the select event button may become “Edit Event”; clicking the button will lead to a page for editing the event lander page view; and blocking a send gift button before the event lander page is created and unlocking, the send gift button once the event lander page is created; pressing the send gift button by a user causing the event lander page to be available for viewing over a network; and causing a message to be sent to the recipient wherein the recipient is a friend for whom the event lander page was created, the message comprising a link to the event lander page.

In another embodiment, an event lander editing page view for inputting contents of a greeting message, comprises a field for inputting a text message. In certain aspects, the event lander page view for inputting contents of a greeting message may additionally include a field for inputting a text message wherein the field for inputting a text message is limited to 150 characters. In other various aspects of the embodiment, the event lander editing page view for inputting contents of a greeting message further comprises a title; and means for inputting multimedia content. In another aspect of the embodiment, the event lander editing page view for inputting contents of a greeting message is an editing page that includes a field for uploading picture files. In yet another aspect of the embodiment, the event lander editing page view for inputting contents of a greeting message is a field that may include a camera icon indicating that the field is for uploading pictures files. In another aspect of the embodiment, the event lander editing page view for inputting contents of a greeting message includes a text that may be displayed to indicate supported file formats including Jpeg, tiff, png, and other supported formats. In another embodiment, the event lander editing page view for inputting contents of a greeting message is provided wherein the field may include a browse button, a field for displaying the file name and directory path of one or more selected files. In other various aspects of the invention, the event lander editing page view for inputting contents of a greeting message is included wherein an upload button is available once a file is selected. In yet another variation of the embodiment, the event lander editing page view for inputting contents of a greeting message is provided wherein the editing page includes a separate field for uploading video files. Also, the embodiment may variously include the event lander editing page view for inputting contents of a greeting message wherein the field includes a camcorder icon indicating that the field is for uploading video files. In another aspect of the embodiment, the event lander editing page view for inputting contents of a greeting message is provided wherein a text is displayed to indicate supported file formats including MOV, MP4, Mpeg, and one or more additional available video file formats. In other certain aspects of the embodiment, the event lander editing page view for inputting contents of a greeting message is provided wherein the field includes a browse button, a field for displaying the file names and one or more directory paths of one or more selected files. In yet another aspect of the embodiment, the event lander editing page view for inputting contents of a greeting message further comprises an upload button once one or more files are selected. In a further aspect of the embodiment, the event lander editing page view includes a field for adding gifts. The field may include a button that links to a separate page view for adding gifts such as gift cards.

### BRIEF DESCRIPTION OF THE DRAWINGS

FIG. 1 is a functional block diagram of an event lander system.

FIG. 2 is a flow chart for a method for providing an event lander system.

FIG. 3 is a block diagram of an event lander.

FIG. 4 is a flow chart for a computer implemented method of providing a social network based peer computing system.

FIG. 5 is a functional block diagram of a computer-implemented platform.

FIG. 6 is a block diagram of a computer system for providing a method of social gifting.

FIG. 7 is a functional block diagram of a computer readable medium for providing a method of social gifting.

FIG. 8 is a functional block diagram of a processor readable device having processor readable code embodied thereon for programming at least one processor to perform a method of social gifting.

FIG. 9 is functional block diagram of a computer implemented apparatus for providing a method of social gifting.

FIG. 10 is a functional block diagram of a customizable application system for providing a method of social gifting.

FIG. 11 is a flow chart for a method for providing a social gifting system.

FIG. 12 is a flow chart for a computer implemented method of social gifting.

FIG. 13 is a block diagram of an event lander editing page view for selecting an event.

FIG. 14 is flow chart for a method of providing an event lander editing page view for selecting an event.

FIG. 15 is a functional block diagram of an event lander editing page view.

FIG. 16 is a wireframe site map of Bloqsy website.

FIG. 17 is a page view for a welcome page of the Bloqsy website.

FIG. 18 is a page view for a Facebook connect page.

FIG. 19 is a page view for a select event page.

FIG. 20 is a page view for a select event page.

FIG. 21 is a page view for a webpage for creating a multimedia message.

FIG. 22 is a page view for a webpage for purchasing a gift card.

FIG. 23 is a page view of a closed event page.

FIG. 24 is a block diagram illustrating components of an exemplary operating environment.

FIG. 25 is a functional block diagram of an exemplary computer system.

### DETAILED DESCRIPTION OF THE INVENTION

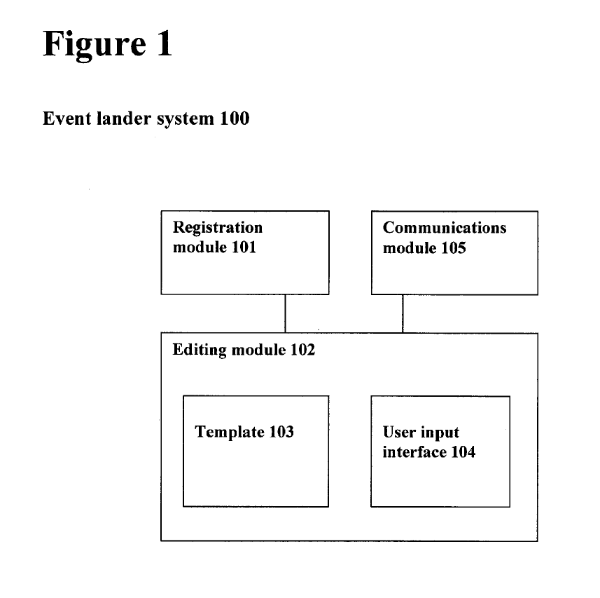

According to one embodiment as shown in FIG. 1, an event lander system 100 comprises a registration module 101 for a user to input user information and register with said event lander system as a registered user; an editing module 102 having a template 103 and a user input interface 104 for a registered user to select a trigger event, and to create an event lander page with user contents, said editing module is enabled such that said user contents comprises one or more items selected from the group consisting of text, image, audio, video, hyperlink, and gift card, said registered user is identified to said event lander page as an initiator, part of said user contents is designated as initiator contents, said initiator contents may only be edited by said initiator before said trigger event occurs. In certain aspects the embodiment may include initiator content that comprises a title and page layout, wherein said initiator content can be viewed by participant and recipient before a trigger event; at least part of said user contents may optionally be designated by said initiator as confidential contents that can only be viewed by said initiator before said trigger event occurs; and a communications module 105 for sending a notification to one or more recipients, said notification comprising an address of said event lander page; wherein before said trigger event occurs, viewing of said confidential contents is restricted to the one who created it; wherein after said trigger event occurs, viewing of said confidential contents is not restricted to the one who created it. In other various aspects the embodiment may include a feature wherein said trigger event comprises a release date. In yet other aspects of the embodiment, said event lander editing module is adapted to further allow a registered user other than said initiator to edit said user contents of said event lander page, wherein said registered user other than said initiator is identified to said event lander page as a participant, user contents created by said participant is identified as participant contents and is identified to said participant, said participant contents may only be edited by said participant, at least part of said participant contents may be designated by said participant as confidential contents. In yet another aspect of the embodiment, the event lander editing module is adapted to allow said initiator to designate a recipient, wherein said recipient is given exclusive right to view at least part of said user contents such as a gift card.

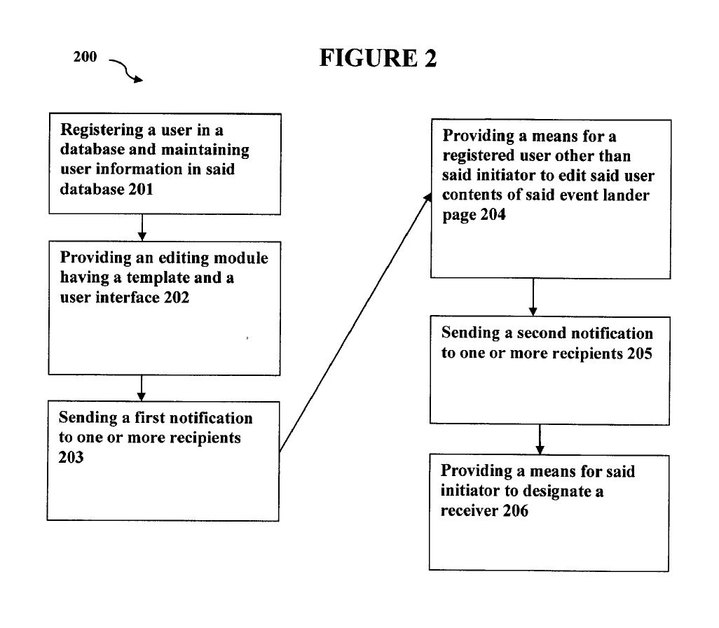

According to another embodiment as shown in FIG. 2, a method for providing an event lander system 200 comprises the following steps: registering a user in a database and maintaining user information in said database 201; providing an editing module having a template and a user interface 202 for a registered user to select a trigger event, and to create an event lander page with user contents, said editing module is enabled such that said user contents comprises one or more items selected from the group consisting of a text message, an image, an audio, a video, a hyperlink, and a gift card, said registered user is identified to said event lander page as an initiator, part of said user contents is designated as initiator contents, said initiator contents may only be edited by said initiator, at least part of said user contents may optionally be designated by said initiator as confidential contents; and sending a first notification to one or more recipients 203, said notification comprising an identifier of said event lander page; wherein before said trigger event occurs, viewing of said confidential contents is restricted to the one who created it; wherein after said trigger event occurs, viewing of said confidential contents is not restricted to the one who created it. In certain aspects of the embodiment, the method may further comprise steps for providing a means for a registered user other than said initiator to edit said user contents of said event lander page 204, wherein said registered user other than said initiator is identified to said event lander page as a participant, user contents created by said participant is identified as participant contents and is identified to said participant, said participant contents may only be edited by said participant, at least part of said participant contents may be designated by said participant as confidential contents. In certain other aspects of the embodiment, the method further comprises sending a second notification to one or more recipients 205. The second notification includes an identifier of the event lander page and informs the recipients that the participant has posted a greeting on the event lander page. In other various aspects of the embodiment, the method further comprises providing a means for said initiator to designate a recipient 206 in relation to said event lander pager, wherein said done is given exclusive right to view part of said user contents designated as recipient exclusive contents, said recipient exclusive contents including the amount of said gift card. In yet another aspect of the embodiment, the method further comprises integrating the event lander system with one or more social networking applications.

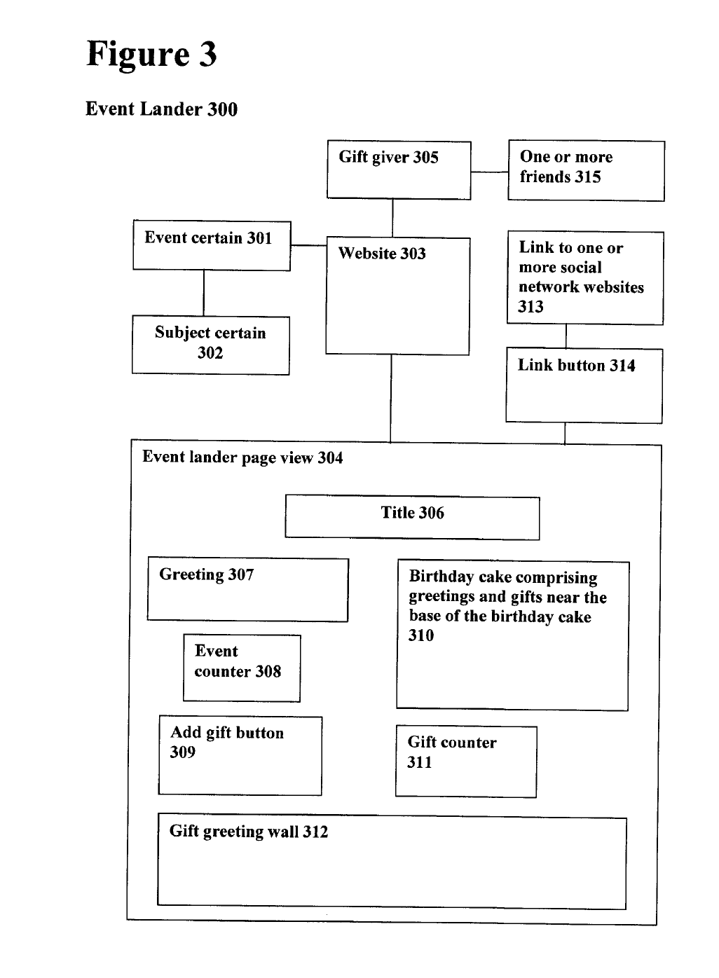

According to another embodiment as shown in FIG. 3, an event lander 300 comprises an event certain 301 that will happen in the future, a subject certain 302 associated with the event certain, a website 303 that allows a sponsor and at least one gift giver to add messages, gift cards, photos, videos, music, and other digital media to be stored therein, said media locked such that the gift givers and recipient may not access the media stored therein and that at the appointed time, the recipient may access the stored media and redeem one or more gifts, and an event lander page view 304 comprising public content and private content. In another aspect of the embodiment, the event lander further comprises integrating with one or more social networking applications. In another aspect of the embodiment, the event lander further comprises at least one gift giver 305 that is a registered user that may be able to view the event lander page and may be able to add user content. In other certain aspects, the embodiment may include at least one gift giver that is an unregistered user that may be able to view the event lander page but may not be able to add user content. In various aspects, the event lander may also include a feature wherein the registered users may be selected from the group consisting of initiator, participant, and recipient. In yet another aspect of the embodiment, the event lander website is associated with one or more Facebook® pages. In another aspect of the embodiment, the event lander further comprises a title 306, a greeting 307, an event counter 308 comprising a timer countdown, said timer countdown including one or more time categories of days, hours, minutes, and seconds until the appointed time to open gifts, an add gift button 309, a birthday cake 310 comprising greetings and gifts near the base of the birthday cake, a gift counter 311, and a gift greeting wall 312 comprising one or more individual gifter blocks. In another aspect of the embodiment, the event lander further comprises a link to one or more social network websites 313 that has one or more registered members, a link button 314 that is displayed on a member's home page at a pre-determined time near a member's birthday, one or more friends 315 that are directed to the event lander where birthday greetings and gift cards can be entered when a friend of the member clicks on the link. In yet another aspect of the embodiment, the event lander further includes an editing module including a template and a user input interface, wherein said editing module is designed to facilitate a registered user to create an event lander page with user contents, said editing module is enabled such that said registered user can edit general content including page layout, graphic design, common greeting, said general content can be viewed by anyone who accesses said event lander at any time; said registered user can edit private content comprising one or more items selected from the group consisting of text, image, audio, video, hyperlink, and gift card; said registered user can edit confidential content comprising one or more items selected from the group consisting of text, image, audio, video, hyperlink, and gift card; a database for storing said user contents, wherein said user contents are identified to said registered user and said recipient such that viewing of said general content is available to anyone who has access to said event lander, viewing of said private content is restricted to said registered user before said predetermined event occurs, viewing of said confidential content is limited said registered user before said predetermined event occurs, and viewing of said confidential event is limited said registered user and said recipient after said predetermined event occurs; and a database server for delivering said event lander page such that said event lander page is associated with a web browser and one or more applications. In other certain aspects, the event lander further includes an event lander page that may be created for a predetermined event for a predetermined recipient, and more than one registered users may contribute to the same event lander; and a portion of event lander system general content wherein after a first registered user has created an event lander page for said predetermined event for a predetermined recipient, said general content is selected from the group consisting of the layout, theme, generic greeting, counter, and display of contributors at the bottom of page, wherein said portion of event lander system general content is shared with later registered users who contribute additional content to said event lander page. In other various aspects, the event lander may include more than one event lander page may be for a predetermined event for a predetermined recipient, and more than one registered users may contribute to the same event lander and after a first registered user has created an event lander page for said predetermined event for a predetermined recipient, some event lander system general content is selected from the group consisting of the layout, theme, generic greeting, counter, and display of contributors at the bottom of page, is shared with later registered users who contribute contents to said event lander page.

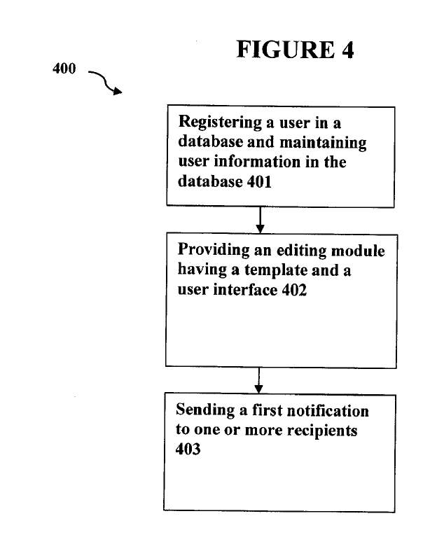

In another embodiment as illustrated in FIG. 4, a computer implemented method 400 including computer-usable readable storage medium having computer-readable program code embodied therein for causing a computer system to perform a method of providing a social network based peer computing system including the following steps: registering a user in a database and maintaining user information in the database 401; providing an editing module having a template and a user interface 402 for a registered user to select a trigger event, and to create an event lander page with user contents, the editing module is enabled such that the user contents comprises one or more items selected from the group consisting of a text message, an image, an audio, a video, a hyperlink, and a gift card. The registered user who created the event lander page is identified to the event lander page as an initiator, part of the user contents is designated as initiator contents, and the initiator contents may only be edited by the initiator. At least part of the user contents may optionally be designated by the initiator as confidential contents. The method further includes sending a first notification to one or more recipients 403, the notification comprising an identifier of the event lander page, such as a web address. Before the trigger event occurs, viewing of the confidential contents is restricted to the one who created it. After the trigger event occurs, viewing of the confidential contents is no longer restricted to the one who created it.

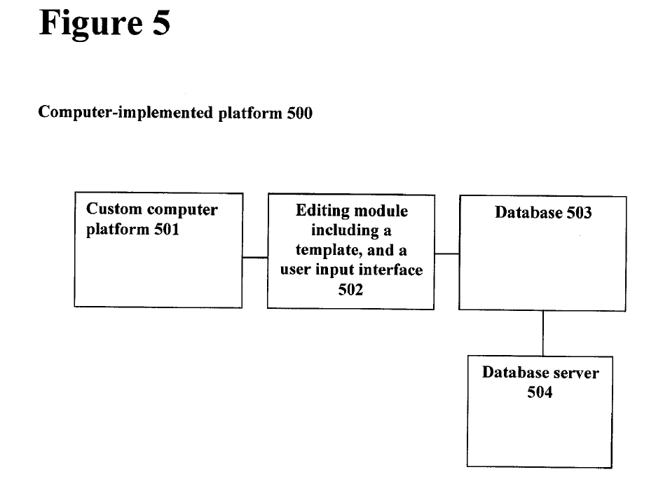

In another embodiment as shown in FIG. 5, a computer-implemented platform 500 including computer-usable readable storage medium having computer-readable program code embodied therein for causing a computer system to perform steps to allow a first user to establish a relationship with a second user in a social network based peer computing system comprises a custom computer platform 501, an editing module including a template, and a user input interface 502, wherein the editing module is designed to facilitate a registered user to create an event lander page with user contents, the editing module is enabled such that the registered user can edit general content including page layout, graphic design, common greeting like that commonly printed on a birthday card. The general content can be viewed by anyone who accesses the event lander at any time. The registered user can edit private content comprising one or more items selected from the group consisting of text, image, audio, video, hyperlink, and gift card. The registered user can edit confidential content comprising one or more items selected from the group consisting of text, image, audio, video, hyperlink, and gift card. The computer-implemented platform 500 further includes a database 503 for storing the user contents, wherein the user contents are identified to the registered user and the recipient such that viewing of the general content is available to anyone who has access to the event lander, viewing of the private content is restricted to the registered user before the predetermined event occurs, viewing of the confidential content is limited to the registered user before the predetermined event occurs, and viewing of the confidential event is limited the registered user and the recipient after the predetermined event occurs. There is also a database server 504 for delivering the event lander page such that the event lander page is properly displayed to a viewer.

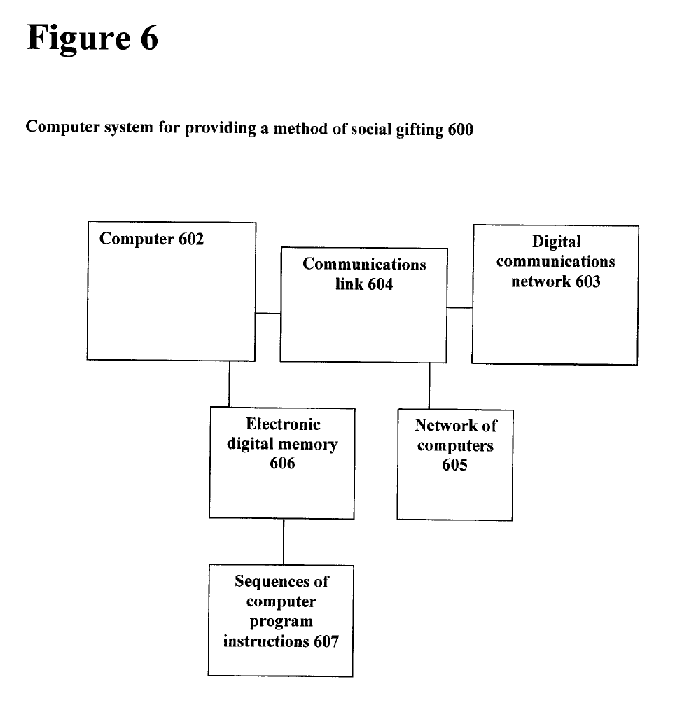

In another embodiment as shown in FIG. 6, a computer system for providing a method of social gifting 600 comprises a computer 602 that is coupled to a digital communications network 603 by a communications link 604 to a network of computers 605; an electronic digital memory 606 in the computer; one or more sequences of computer program instructions 607 stored in the electronic digital memory which, when executed, cause the computer system to perform the steps of registering a user in a database and maintaining user information in the database; providing an editing module having a template and a user interface for a registered user to select a trigger event, and to create an event lander page with user contents. The editing module is enabled such that the user contents comprises one or more items selected from the group consisting of a text message, an image, an audio, a video, a hyperlink, and a gift card. The registered user who created the event lander page is identified to the event lander page as an initiator, part of the user contents is designated as initiator contents, the initiator contents may only be edited by the initiator, and at least part of the user contents may optionally be designated by the initiator as confidential contents. The computer system will further send a first notification to one or more recipients, the notification comprising an identifier of the event lander page. Before the trigger event occurs, viewing of the confidential contents is restricted to the one who created it. After the trigger event occurs, viewing of the confidential contents is not restricted to the one who created it.

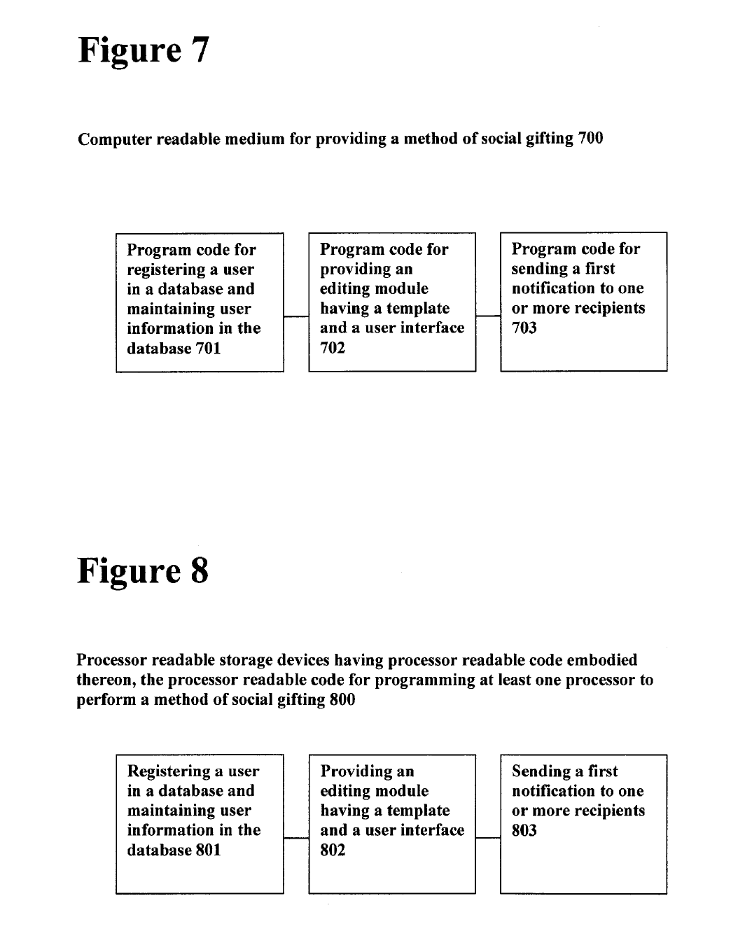

In another embodiment as shown in FIG. 7, a computer readable medium for providing a method of social gifting 700, comprises program code for registering a user in a database and maintaining user information in the database 701; program code for providing an editing module having a template and a user interface 702 for a registered user to select a trigger event, and to create an event lander page with user contents, the editing module is enabled such that the user contents comprises one or more items selected from the group consisting of a text message, an image, an audio, a video, a hyperlink, and a gift card, the registered user is identified to the event lander page as an initiator, part of the user contents is designated as initiator contents, the initiator contents may only be edited by the initiator, at least part of the user contents may optionally be designated by the initiator as confidential contents; and program code for sending a first notification to one or more recipients 703, the notification comprising an identifier of the event lander page; wherein before the trigger event occurs, viewing of the confidential contents is restricted to the one who created it; wherein after the trigger event occurs, viewing of the confidential contents is not restricted to the one who created it.

In another embodiment as shown in FIG. 8, one or more processor readable storage devices having processor readable code embodied on at least one processor readable storage devices, the processor readable code for programming at least one processor to perform a method of social gifting 800, comprises steps for registering a user in a database and maintaining user information in the database 801; providing an editing module having a template and a user interface 802 for a registered user to select a trigger event, and to create an event lander page with user contents, the editing module is enabled such that the user contents comprises one or more items selected from the group consisting of a text message, an image, an audio, a video, a hyperlink, and a gift card, the registered user is identified to the event lander page as an initiator, part of the user contents is designated as initiator contents, the initiator contents may only be edited by the initiator, at least part of the user contents may optionally be designated by the initiator as confidential contents; and sending a first notification to one or more recipients 803, the notification comprising an identifier of the event lander page; wherein before the trigger event occurs, viewing of the confidential contents is restricted to the one who created it; wherein after the trigger event occurs, viewing of the confidential contents is not restricted to the one who created it.

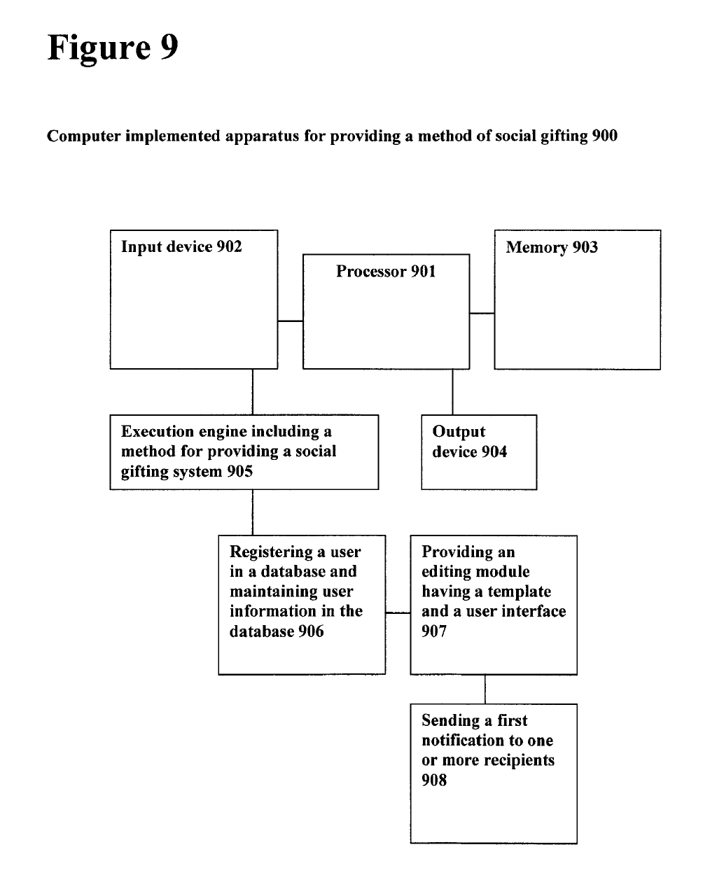

In another embodiment as shown in FIG. 9, a computer implemented apparatus for providing a method of social gifting 900 comprises a processor 901; an input device 902 coupled to the processor; a memory 903 coupled to the processor; an output device 904; and an execution engine 905 including a method for providing a social gifting system comprising the steps for registering a user in a database and maintaining user information in the database 906; providing an editing module having a template and a user interface 907 for a registered user to select a trigger event, and to create an event lander page with user contents, the editing module is enabled such that the user contents comprises one or more items selected from the group consisting of a text message, an image, an audio, a video, a hyperlink, and a gift card, the registered user is identified to the event lander page as an initiator, part of the user contents is designated as initiator contents, the initiator contents may only be edited by the initiator, at least part of the user contents may optionally be designated by the initiator as confidential contents; and sending a first notification to one or more recipients 908, the notification comprising an identifier of the event lander page; wherein before the trigger event occurs, viewing of the confidential contents is restricted to the one who created it; wherein after the trigger event occurs, viewing of the confidential contents is not restricted to the one who created it.

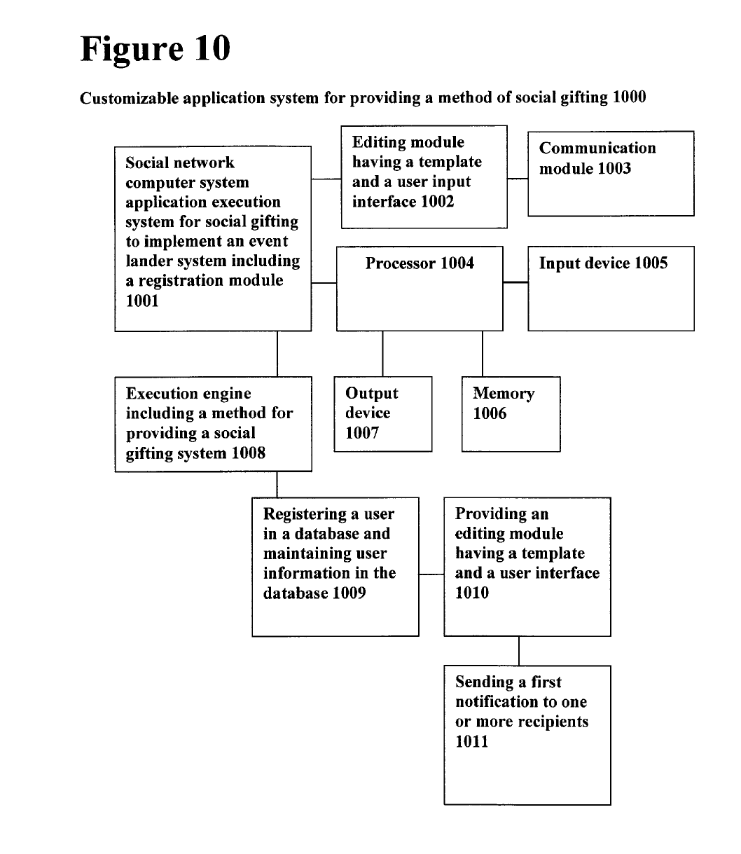

In another embodiment as shown in FIG. 10, a customizable application system for providing a social gifting platform 1000, comprises a social network computer system application execution system for social gifting to implement an event lander system including a registration module 1001 for a user to input user information and register with the event lander system as a registered user; an editing module having a template and a user input interface 1002 for a registered user to select a trigger event, and to create an event lander page with user contents, the editing module is enabled such that the user contents comprises one or more items selected from the group consisting of text, image, audio, video, hyperlink, and gift card, the registered user is identified to the event lander page as an initiator, part of the user contents is designated as initiator contents, the initiator contents may only be edited by the initiator, at least part of the user contents may optionally be designated by the initiator as confidential contents; and a communications module 1003 for sending a notification to one or more recipients, the notification comprising one or more addresses of the event lander page; wherein before the trigger event occurs, viewing of the confidential contents is restricted to the one who created it; wherein after the trigger event occurs, viewing of the confidential contents is not restricted to the one who created it; a processor 1004; an input device 1005 coupled to the processor; a memory 1006 coupled to the processor; an output device 1007; and an execution engine including a method 1008 for providing a social gifting system comprising steps for registering a user in a database and maintaining user information in the database 1009; providing an editing module having a template and a user interface 1010 for a registered user to select a trigger event, and to create an event lander page with user contents, the editing module is enabled such that the user contents comprises one or more items selected from the group consisting of a text message, an image, an audio, a video, a hyperlink, and a gift card, the registered user is identified to the event lander page as an initiator, part of the user contents is designated as initiator contents, the initiator contents may only be edited by the initiator, at least part of the user contents may optionally be designated by the initiator as confidential contents; and sending a first notification to one or more recipients 1011, the notification comprising an identifier of the event lander page; wherein before the trigger event occurs, viewing of the confidential contents is restricted to the one who created it; wherein after the trigger event occurs, viewing of the confidential contents is not restricted to the one who created it.

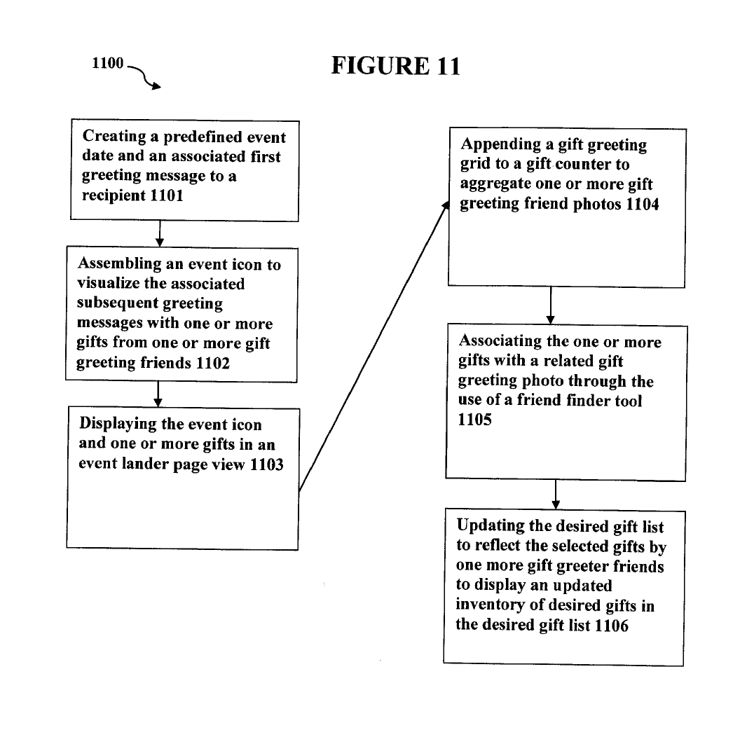

In another embodiment as shown in FIG. 11, a method for providing a social gifting system 1100 comprises steps for creating a predefined event date and an associated first greeting message to a recipient 1101; assembling an event icon to visualize the associated subsequent greeting messages with one or more gifts from one or more gift greeting friends 1102; displaying the event icon and one or more gifts in an event lander page view 1103; and appending a gift greeting grid to a gift counter to aggregate one or more gift greeting friend photos 1104.

In another aspect of the embodiment as shown in FIG. 11, the method for providing a social gifting system, includes the previous steps wherein the one or more gifts in an event lander page view comprise one or more gift groups, the gift groups selected from the group consisting of gift group 1/five packages in a single row, gift group 2/13×2 packages comprising thirteen packages in two rows, gift group 3/15×2 packages comprising fifteen packages in two rows, and gift group 4/4×2 packages comprising four packages in two rows. In other certain aspects of the embodiment, the social gifting system method includes steps wherein the one or more gifts may be redeemed from one or more participating vendors in one or more categories. In other various aspects of the embodiment, the method for providing a social gifting system further comprises steps for associating the one or more gifts with a related gift greeting photo through the use of a friend finder tool 1105. In some aspects, the method includes steps wherein the event icon is a birthday cake. In other various aspects the method includes steps wherein the social gifting system is a gift registry and wherein an event announcement and a desired gift list is displayed for one or more gift greeter friends. In another aspect of the embodiment, the method further comprises steps for updating the desired gift list to reflect the selected gifts by one more gift greeter friends to display an updated inventory of desired gifts in the desired gift list 1106. In another aspect of the embodiment, the method includes steps wherein the event announcement is associated with a news message.

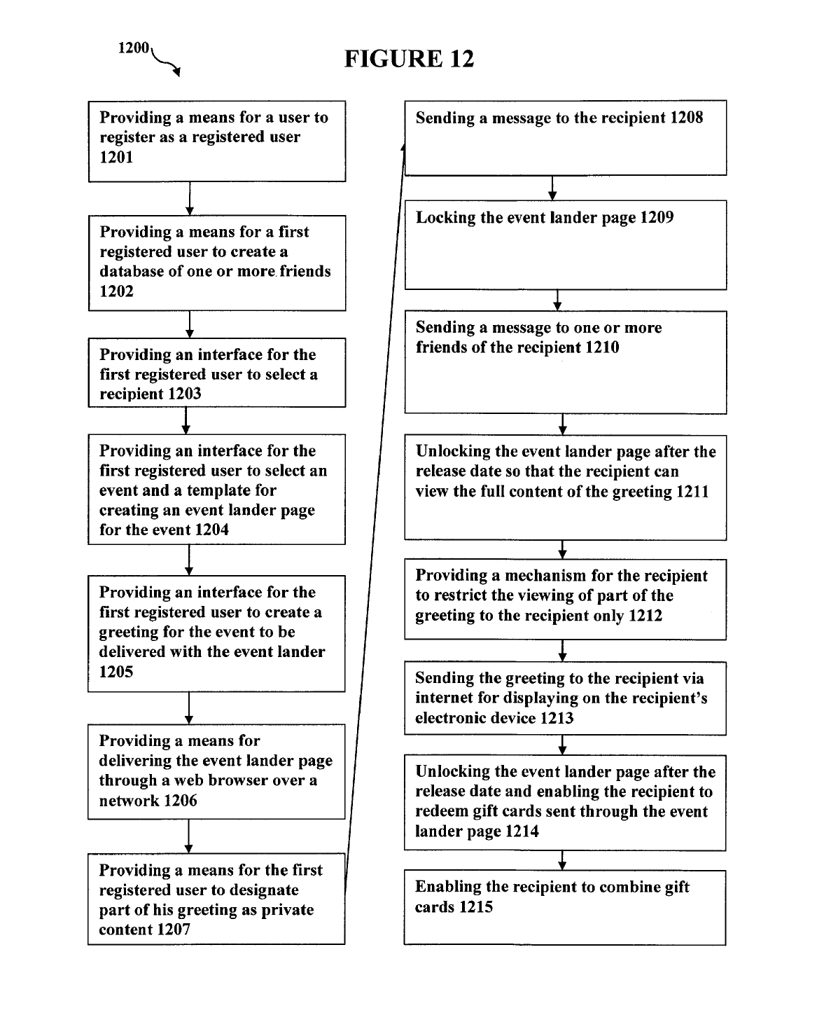

In another embodiment as shown in FIG. 12, a computer implemented method of social gifting, comprises providing a means for a user to register as a registered user 1201 through an interface; providing a means for a first registered user to create a database of one or more friends 1202; providing an interface for the first registered user to select a recipient 1203; wherein the interface comprising program code to be delivered to the initiator's digital device for displaying a select-your-friend page, the select-your-friend page allowing the initiator to select a recipient from a list displayed on the web page; wherein the interface comprising program code to be delivered to the initiator's digital device for displaying a select-your-friend page, the select-your-friend page allowing the initiator to search for a friend from a database of friends and to select a recipient from a search result list; providing an interface for the first registered user to select an event and a template for creating an event lander page for the event 1204; providing an interface for the first registered user to create a greeting for the event to be delivered with the event lander 1205, the greeting comprising one or more items selected from the group consisting of a message, a picture, a video, and a gift card; wherein the gift card comprises a proprietary gift card, the proprietary gift card can be redeemed by the recipient to buy vendor gift cards; providing a means for delivering the event lander page through a web browser over a network 1206, the event lander page displaying the greeting, part of the content of the greeting being locked until a release date, the event lander page comprising an add-gift button; providing a means for the first registered user to designate part of his greeting as private content 1207 that cannot be displayed on the event lander page after the release date; wherein the add-gift button in blocked to the recipient such that the recipient cannot add gift to itself; sending a message to the recipient 1208, the message comprising a link to the event lander page; wherein the message is posted on the recipient's social network webpage wall; locking the event lander page 1209; sending a message to one or more friends of the recipient 1210; unlocking the event lander page after the release date so that the recipient can view the full content of the greeting 1211; providing a mechanism for the recipient to restrict the viewing of part of the greeting to the recipient only 1212; sending the greeting to the recipient via internet for displaying on the recipient's electronic device 1213, after the release date; unlocking the event lander page after the release date and enabling the recipient to redeem gift cards sent through the event lander page 1214; and enabling the recipient to combine gift cards 1215.

In another aspect of the embodiment as shown in FIG. 12, the computer implemented method of social gifting, further comprises steps for providing a registered second user through an interface; providing a means for the second registered user to select the event lander page and to add a second greeting on the event lander page, the greeting comprising one or more items selected from the group consisting of a message, a picture, a video, and a gift card; wherein the gift card comprises a proprietary gift card, the proprietary gift card can be redeemed by the recipient to buy vendor gift cards, wherein the second greeting comprises participant content associated with one or more privacy privilege status identifiers, wherein the privacy privilege status identifiers are selected from the group consisting of public participant content, confidential content, and optionally private content; associating the second greeting with the second registered user, locking the second greeting so that the confidential content and the private content of the second greeting can only be viewed by the second registered user; sending a second message to the recipient, the message comprising a link to the event lander page; wherein the message may be posted on the recipient's Facebook wall to notify the recipient that the second registered user has posted a greeting on the event lander page; and sending a message to one or more friends of the recipient.

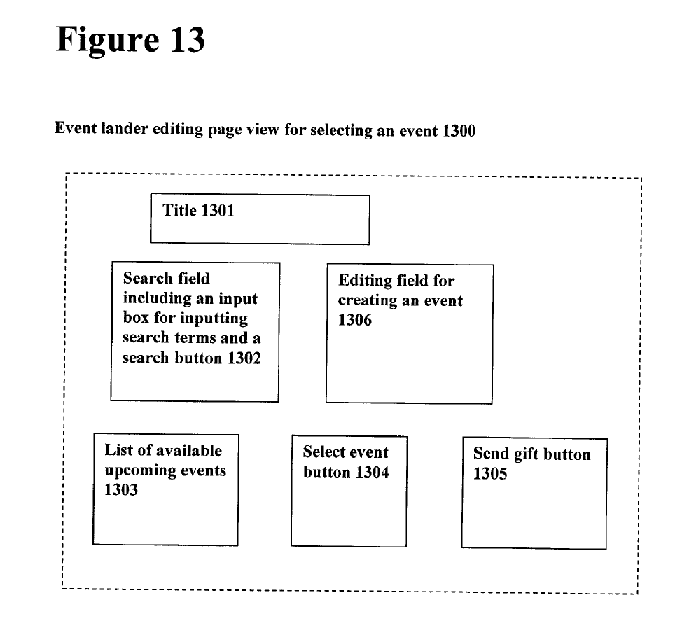

In another embodiment as shown in FIG. 13, an event lander editing page view for selecting an event 1300, comprises a title 1301; a search field including an input box for inputting search terms and a search button 1302; a list of available upcoming events 1303; a select event button 1304 displayed next to each available upcoming event, the select event button comprising a link to a page view for editing or creating an event lander page for the upcoming event, the text label of the select event button changing depending on whether an event lander page is already created; for example, before an event lander page is created, the label of the button may be “Create Event”, once an event lander page is created, the label of the select event button may become “Edit Event”, clicking the button will lead to a page for editing the event lander page view; and a send gift button 1305 that is displayed next to each available upcoming event, the send gift button being blocked before the event lander page is created, once the event lander page is created and the send gift button is unblocked, pressing the send gift button by a user will cause the event lander page to be published. For example, the event lander page may become available for viewing over a network, and a message may be sent to a recipient, for example, to whom the event lander page was created, the message including a link to the event lander page. In various aspects of the embodiments, the event lander editing page view may include an editing field for creating an event 1306. The editing field may simply be a link to a new page with various editing fields for creating an event. In other various aspects of the embodiments, if there are more than one available upcoming events, the available upcoming events may be organized by dates or they may be organized by the people's names for whom the events are for.

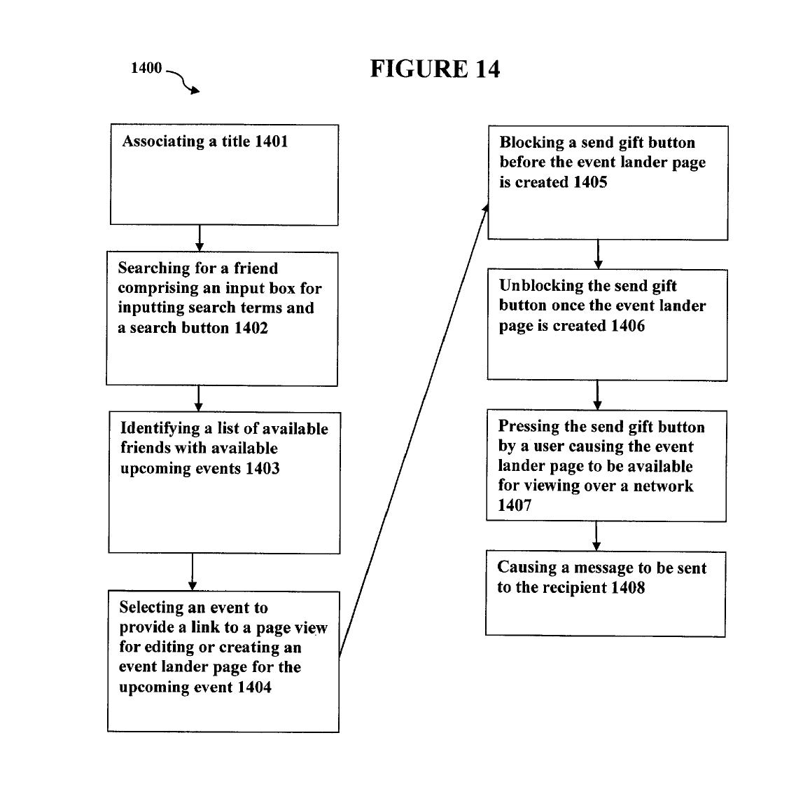

In another embodiment as shown in FIG. 14, a method for providing an event lander editing page view for selecting an event 1400, comprises steps for associating a title 1401; searching for a friend comprising an input box for inputting search terms and a search button 1402; identifying a list of available friends with available upcoming events 1403, the upcoming events comprising birthdays, anniversaries, and weddings; if there is no such upcoming event, there is no list. The list may be organized chronologically. For each available friend with an available upcoming event, the date, the friend's name, and a description of the event are displayed. Additional steps include selecting an event to provide a link to a page view for editing or creating an event lander page for the upcoming event 1404, the text label of the select event button changing depending on whether an event lander page is already created; wherein before an event lander page is created, the label of the button may be “Create Event”, once an event lander page is created, the label of the select event button may become “Edit Event”; clicking the button will lead to a page for editing the event lander page previous stored; and blocking a send gift button before the event lander page is created 1405, and unblocking the send gift button once the event lander page is created 1406; pressing the send gift button by a user causing the event lander page to be available for viewing over a network 1407; and causing a message to be sent to the recipient 1408 wherein the recipient is a friend for whom the event lander page was created, the message comprising a link to the event lander page.

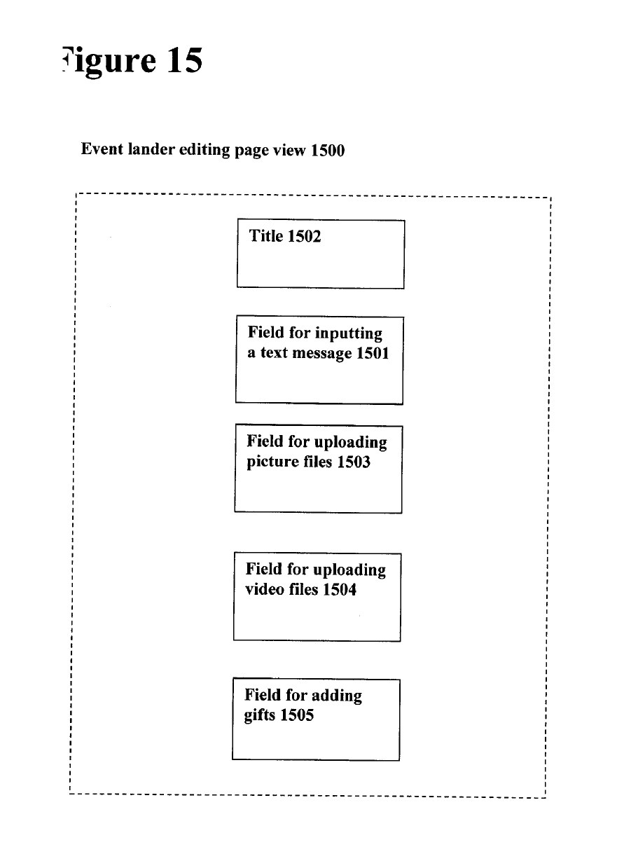

In another embodiment as shown in FIG. 15, an event lander editing page view 1500 for inputting contents of a greeting message, comprises a field for inputting a text message 1501. In certain aspects, the event lander page view for inputting contents of a greeting message may additionally include a field for inputting a text message wherein the field for inputting a text message is limited to 150 characters. In other various aspects of the embodiment, the event lander editing page view for inputting contents of a greeting message of claim 38, further comprises a title 1502; and means for inputting multimedia content. In another aspect of the embodiment, the event lander editing page view for inputting contents of a greeting message is an editing page that includes a field for uploading picture files 1503. In yet another aspect of the embodiment, the event lander editing page view for inputting contents of a greeting message is a field that may include a camera icon indicating that the field is for uploading pictures files. In another aspect of the embodiment, the event lander editing page view for inputting contents of a greeting message includes a text that may be displayed to indicate supported file formats including Jpeg, tiff, png, and other supported formats. In another embodiment, the event lander editing page view for inputting contents of a greeting message is provided wherein the field may include a browse button, a field for displaying the file name and directory path of one or more selected files. In other various aspects of the invention, the event lander editing page view for inputting contents of a greeting message includes an upload button that is available once a file is selected. In yet another variation of the embodiment, the event lander editing page view for inputting contents of a greeting message is provided wherein the editing page includes a separate field for uploading video files 1504. Also, the embodiment may variously include the event lander editing page view for inputting contents of a greeting message wherein the field includes a camcorder icon indicating that the field is for uploading video files. In another aspect of the embodiment, the event lander editing page view for inputting contents of a greeting message is provided wherein a text is displayed to indicate supported file formats including MOV, MP4, Mpeg, and one or more additional available video file formats. In other certain aspects of the embodiment, the event lander editing page view for inputting contents of a greeting message is provided wherein the field includes a browse button, a field for displaying the file names and one or more directory paths of one or more selected files. In yet another aspect of the embodiment, the event lander editing page view for inputting contents of a greeting message further comprises an upload button once one or more files are selected. In a further aspect of the embodiment, the event lander editing page view includes a field for adding gifts 1505. The field may include a button that links to a separate page view for adding gifts such as gift cards.

### Exemplary Operating Environments, Components, and Technology

In the following examples, an exemplary event lander system operated as a website, www.bloqsy.com, is described to further illustrate the operating principles of the current invention.

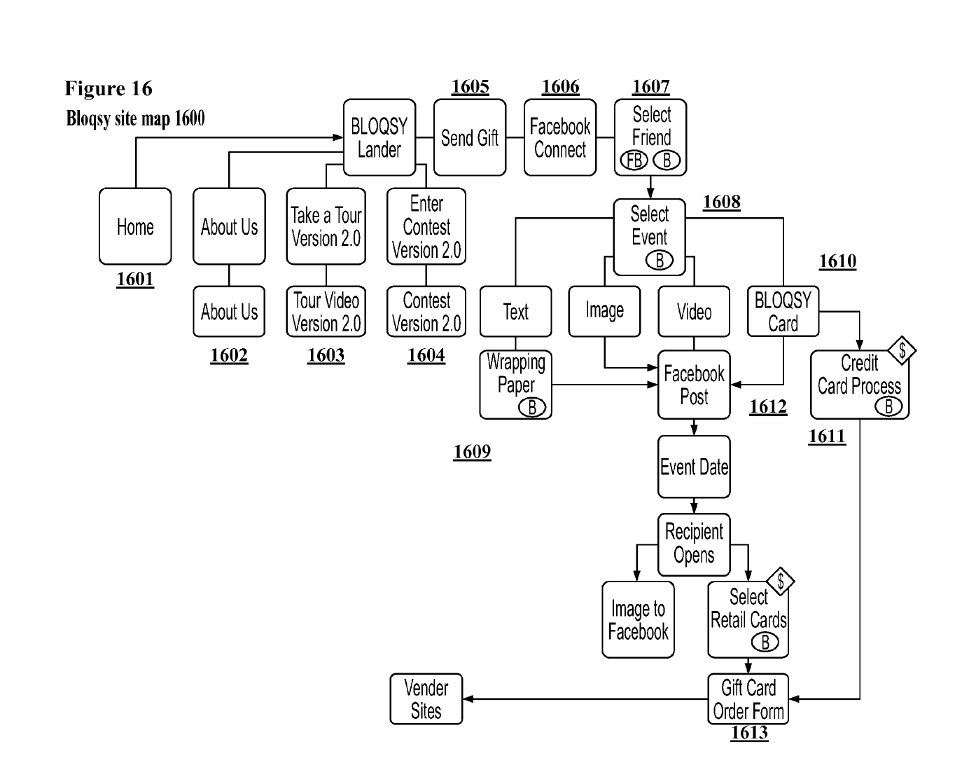

FIG. 16 is a wireframe site map of the Bloqsy website 1600. From the home page 1601 of the Bloqsy lander, links are provided to pages or modules including About Us 1602, Take a Tour 1603, Enter Contest 1604, and Send Gift 1605. Each page or module may include multiple linked pages. The Send Gift module is the largest module and includes the major functions of the Bloqsy lander. The Send Gift sequence starts with a Facebook Connect page 1606 for new users; alternatively, a login page for existing users. After connecting with Facebook or logging in, a user is led to the Select Friend 1607 and Select Event 1608 page(s) to select a friend and an event on an event date to create an event lander page. After selecting an event, the Bloqsy website will prompt the user to input multimedia content of the web lander page using multimedia tools 1609 including Text, Wrapping Paper, Image, and Video tools. There is also a Bloqsy Gift Card function 1610 including a Credit Card Processing function 1611 for the user to purchase a Bloqsy gift card on the Bloqsy website. Once the web lander page is created, the Facebook Post function 1612 is triggered and a message regarding the page is posted on the recipient's Facebook wall. By default, the event lander page is closed before the event date. On the event date at an event time, the page becomes open and becomes available for the Recipient to open the page. When the event lander page opens after the event date, the recipient will also be able to redeem the Bloqsy gift card for store gift cards such as Target and Starbucks gift cards using a Gift Card Order Form 1613. The user may use the store gift cards on the respective vender sites or in the respective physical stores.

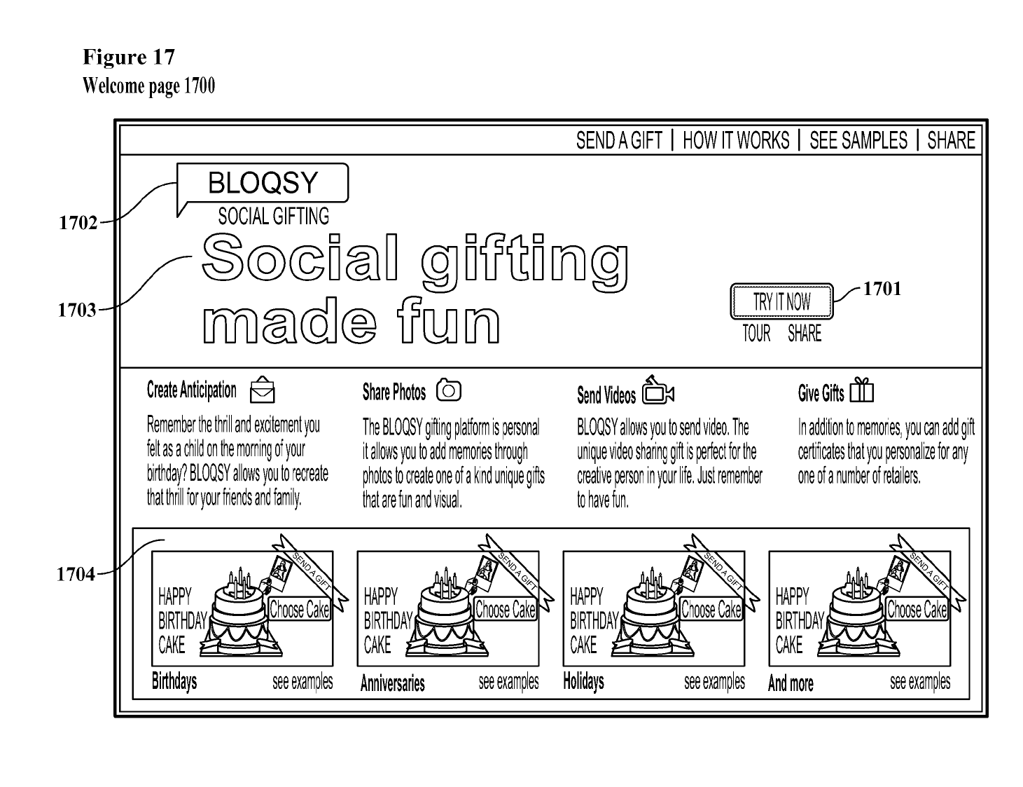

A user may reach the Bloqsy website by typing in the Bloqsy web address in his browser. For example, the user will see a welcome page 1700 as shown on FIG. 17. There is a “Try It Now” button 1701 displayed prominently on the page. The page displays a “BLOQSY” logo 1702 and a banner “Social Gifting Made Fun” 1703. At the lower part of the page, there are pictures and short descriptions 1704 that introduce the features and functions of the Bloqsy event lander system such as Creates Anticipation, Share Photos, Send Videos, and Give Gifts. The pictures and the accompanying captions suggest the uses of the Bloqsy website such as uses for birthdays, anniversaries, holidays, and more. Suppose here the user is a new user, he clicks on the “Try It Now” button, and he will be asked to input his name. He may also be asked to input his birthday and email address. Optionally, for security and identification purposes, the user may be asked to select some challenge questions such as his favorite high school teacher, the street he grew up on, etc. The user may also be asked to choose a login name and a password. The login name can conveniently be his email address. The user becomes a registered user after registration. Alternatively, the new user may use a Facebook login.

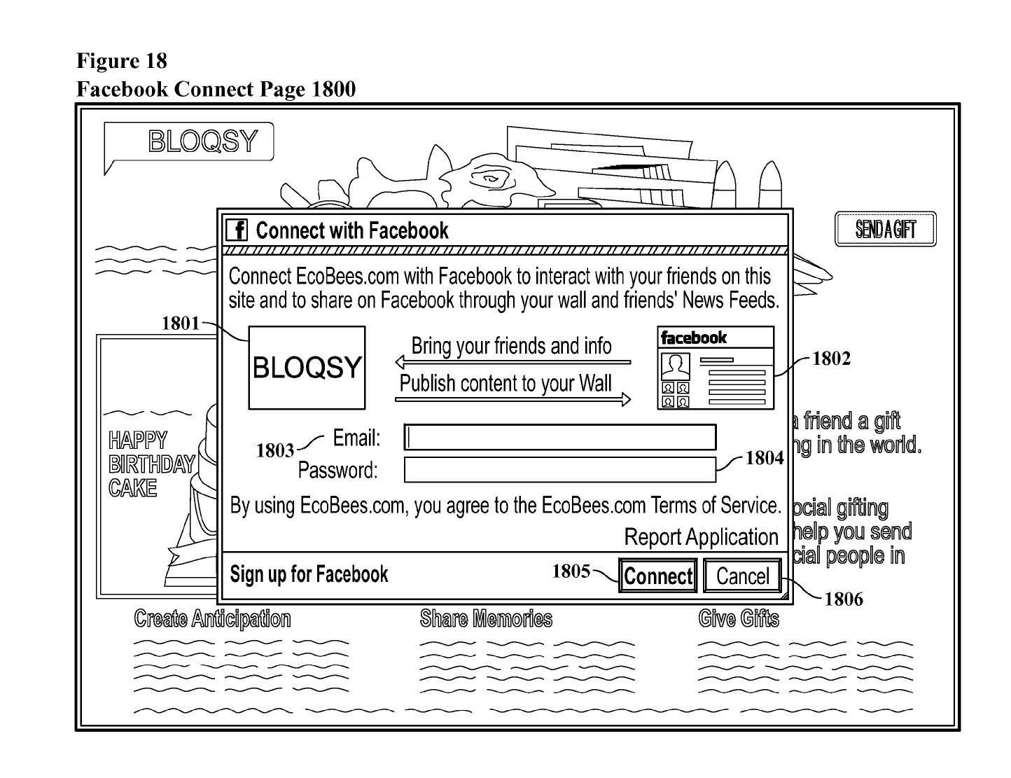

In another example as shown in FIG. 18, the Bloqsy website has a Facebook connect page 1800 that lets a new user login using “Facebook Login” by inputting login information for Facebook. The login page has a Bloqsy logo 1801 and a Facebook logo 1802 on the opposite sides of the page. Between the two logos are an arrow pointing from the Bloqsy logo to the Face logo with the caption “Publish content to your Wall” and another arrow pointing from the Facebook logo to the Bloqsy logo with the caption “Bring your friends and info.” There is an email address field 1803 for the user to input an email address and a password field 1804 to input a password. There is a “Connect” button 1805 to begin the connection process with Facebook, and there is a “Cancel” button 1806 to cancel the process. The Bloqsy website may also have functions to import additional information from the registered user's Facebook, Myspace, Linkedin, and/or other social network websites. For example, the Bloqsy website may request permission to connect with Facebook. If the registered user has a Facebook account and he grants permission, he may input his Facebook login information, and the Bloqsy website may import the registered user's basic information, be able to post on the user's Facebook wall, and access the registered user's friend list on Facebook. In other aspects of the embodiment, the Bloqsy website may also request to import contact lists from the registered user's other online accounts such as email accounts as wells as contact information stored on the registered user's computer such as Microsoft Outlook contact information. The information retrieved may include a contact's birthday information, anniversary information, and other dates and events the registered user may want to greet the contact with.

After signing up with Bloqsy website, a user will be able to create an event lander page by following a few simple steps including (1) selecting a contact's upcoming event such as a birthday, (2) select a template, (3) write a short greeting message and optionally upload photos and videos, and optionally (4) purchase a gift card for the contact.

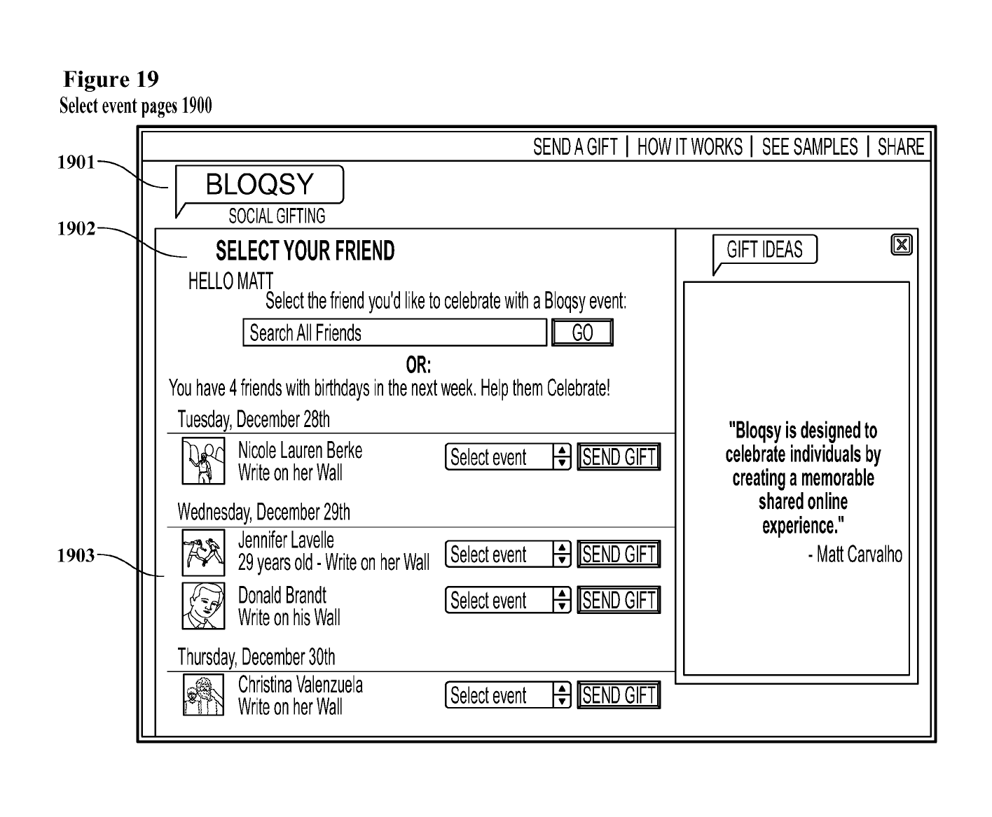

In an example shown in FIG. 19, the Bloqsy website has a select event page 1900 for searching for a friend and a listing of events for celebrating using Bloqsy. The Bloqsy logo 1901 is displayed at the top of the page. Below the logo is a search field 1902 for searching for a friend including a prominent caption “Select Your Friend” in large and bold font, a text input box for a user to input a name to be searched for, and a “GO” button next to the text input field. At the lower part of the page is an event list 1903 including an automatically generated list of upcoming events from the registered user's contact information, such as the contacts' upcoming birthdates. The events are organized by the nature of the event, such as upcoming birthdays, and are sorted by dates of the events. Each event is identified by the name of the individual, a picture of the individual if available, and there are buttons and/or menu selections for “Select Event” and “Send Gift” at each listed event. If the list is too long to be displayed on the page, a scroll bar is displayed, and the event list may be separately scrolled. The word “OR” in bold and large font is displayed between the search field and the event list, indicating that there are two methods to select an event for celebrating on Bloqsy. At the right side of the page is shown a wise saying that encourages gift giving on Bloqsy such as “Bloqsy is designed to celebrate individuals by creating a memorable shared online experience.”

The registered user may simply click on an event identified by Bloqsy website, for example, an upcoming birthday for a contact. Alternatively, suppose a contact's birthday information was not already in the system, the registered user may search for a contact in his contact list or create a new contact. The registered user may manually input a contact's birthday information in Bloqsy website. Thus, a registered user may select an event prompted by the Bloqsy website or may create an event manually. The registered user may then create an event lander page for the event.

The following example illustrates how a registered user may create an event lander page to celebrate a contact's upcoming birthday. For convenience of description, the following terminology is used. The registered user is identified to the event lander page as the Initiator because he first created the event lander page. The contact for whom the event lander page is created is identified to the event lander page as the Recipient because Recipient will be receiving gifts and greeting messages. Gifts and greeting messages are collectively called greetings. A Participant is another registered user who adds greetings to the event lander page after Initiator has created it.

Greeting messages include text, photo, audio, video, url, and other contents deliverable via the web. The Bloqsy system first checks Recipient's identity to see if a birthday event lander page is already created for Recipient. The identification information may include Recipient's first name and last name, email address, and birthday. If an event lander page for Recipient's birthday is already created by someone else, Initiator will be taken to that page, and Initiator may decide whether to join on that page or to create a new page. Suppose here that either there was no existing event lander page or Initiator decides to create a new event lander pager.

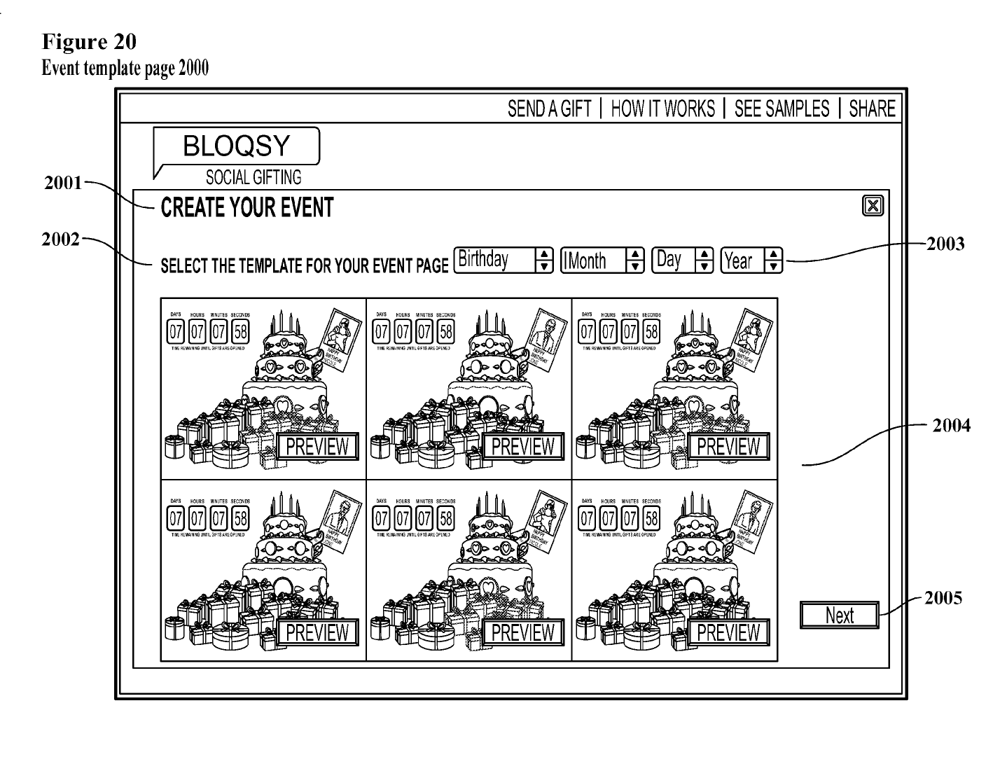

As shown in FIG. 20, the Bloqsy website presents Initiator with an event template page 2000 with a number of templates for him to create the event lander page once Initiator has selected a particular event. The page has a title “Create Your Event” 2001 at the top of the page. Below the title is short instruction “Select the Template for Your Event Page” 2002 and dropdown menus 2003 for selecting “Birthday”, “Month”, “Day”, and “Year”. Six thumbnails of templates 2004 are displayed below the short instruction in two rows and occupy the main part of the page. Each template, as shown by the thumbnail, includes a countdown timer to the event and includes digits for days, hours, minutes, and seconds until the event time. The design of the templates may include gift boxes and a birthday cake, as shown, and may include other designs. If a photo of Recipient is available, it is included on the template in some designs. The page may also include themes that are appropriate for the event, in case of birthdays, birthday themes, and in case of anniversaries, anniversary themes. At the lower part of each thumbnail is a Preview button including a link to a preview page of the template. If there are more thumbnails of templates than that can be displayed on the screen, a scroll bar will be displayed for the user to scroll through the thumbnails. The user selects a template by clicking on the thumbnail. The thumbnail will be highlighted, and the user clicks on a “Next” button 2005 on the right side of the page to go to the next step of creating the event lander page.

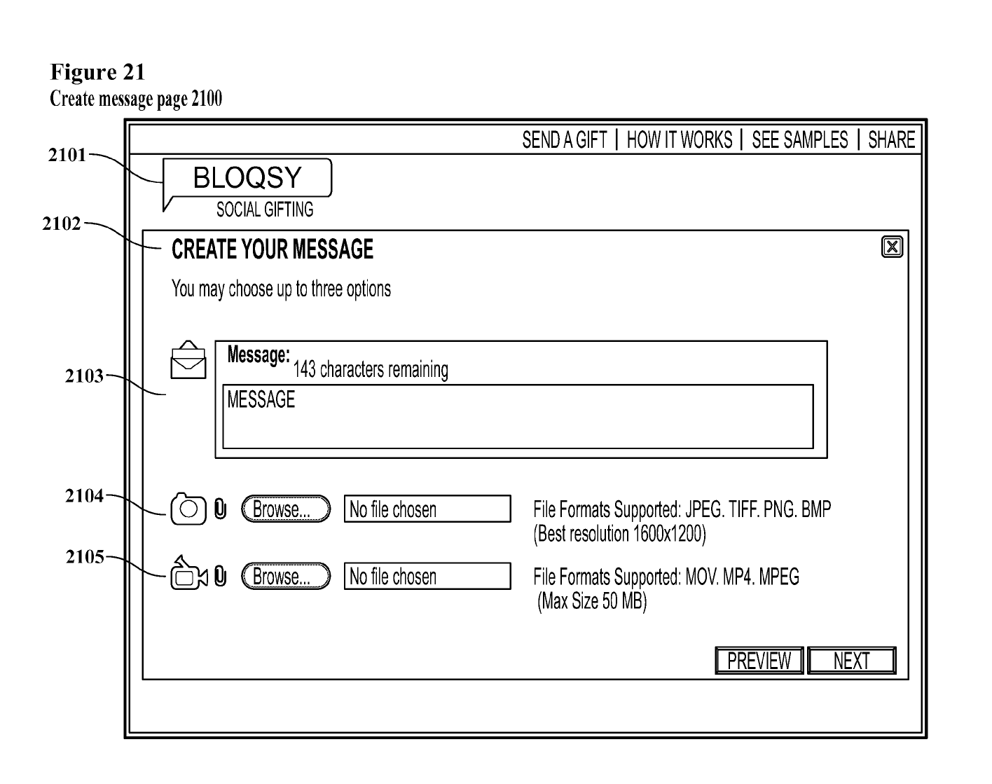

FIG. 21 shows a create message page 2100 on the Bloqsy website that includes convenient features for a user to input a greeting message and to upload photos, videos, and other files. At the top of the page is the Bloqsy logo 2101. Below the logo is the title of the page “Create Your Message” 2102 in large and bold font. Further below is a text message field 2103 for inputting a text message. In this example the message is limited to 150 characters, and a character counter for displaying the number of remaining available characters is displayed above a text message box for typing the message. Below the text message box is a photo uploading field 2104 including a camera icon, a paper clip icon, a browse button, and a field for displaying the file location of the picture file to be uploaded. A short note “File Formats Supported: JPEG, TIFF, PNG, BMP (Best resolution 1600×1200)” is displayed next to the photo uploading field. Below the photo uploading field is a video uploading field 2105 including a camcorder icon, a paper clip icon, a browse button, and a field for displaying the location of the selected video file. A short note “File Formats Supported: MOV, MP4, MPEG (Max size 50 MB)” is displayed next to the video uploading field. At the bottom of the page are a “Preview” button for previewing the greeting message and a “Next” button for continuing on to the next step.

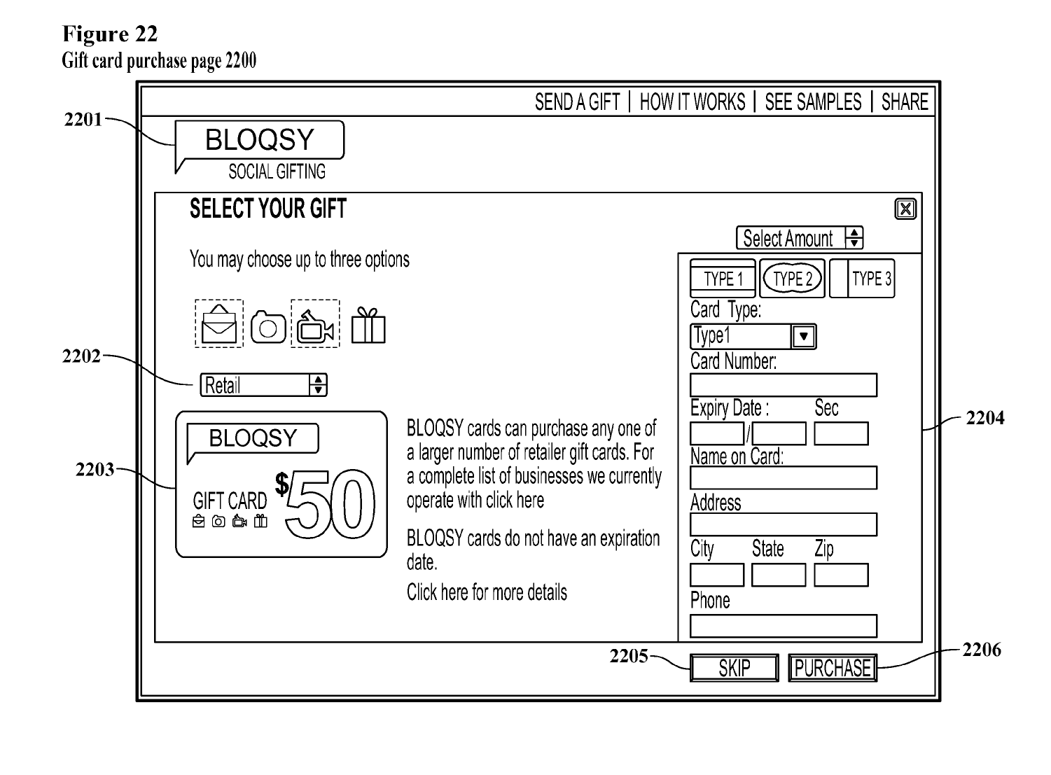

FIG. 22 shows a gift card purchase page 2200 of the Bloqsy website for a user to buy a gift card. The page has a title “Select Your Gift” 2201 and on the upper left side. Below the title is a drop down menu 2202 for a user to select from different kinds of gift cards including a retail gift card. On the lower left side of the page is a picture of a $50 Bloqsy gift card 2203. A note is displayed next to the gift card that reads “Bloqsy cards can purchase anyone of a large number of retailer cards, for a complete list of businesses we currently operate with, Click here. Bloqsy cards do not have an expiration date. Click here fore more details.” On the right side of the page is a credit card purchase area 2204 for a user to input information for purchasing a gift card that includes: a dropdown menu for choosing an amount of the gift card to be purchased, a drop down menu for selecting the type of credit card used including Visa, Mastercard, American Express, etc., fields for inputting credit card number, expiration date, security code, name on card, billing address, and billing phone number. Below the credit card purchase area are a “Skip” button 2205 and a “Purchase” button 2206. A user may click the Skip button to skip the gift card purchase step; alternatively, a user may fill out the information in the input fields on the page and click the Purchase button to buy a gift card.

After purchasing a gift card, the user can preview the event lander page. A unique feature of the Bloqsy website is that the event lander page can be sent as a closed page or an open page. By default, the event lander page is sent as a closed page, the greeting text, photo, video, and gift sent by Initiator will not be viewable by Recipient until a trigger event occurs. In this case, the trigger event is the Recipient's birthday. This is the unique way the Bloqsy website creates expectation for the Recipient. After the trigger event, the closed event lander page opens, and Recipient will be able to view the contents on the event lander page including the message text, picture, video, and a gift card. Initiator may preview both the closed page and the open page as it will show after the event date.

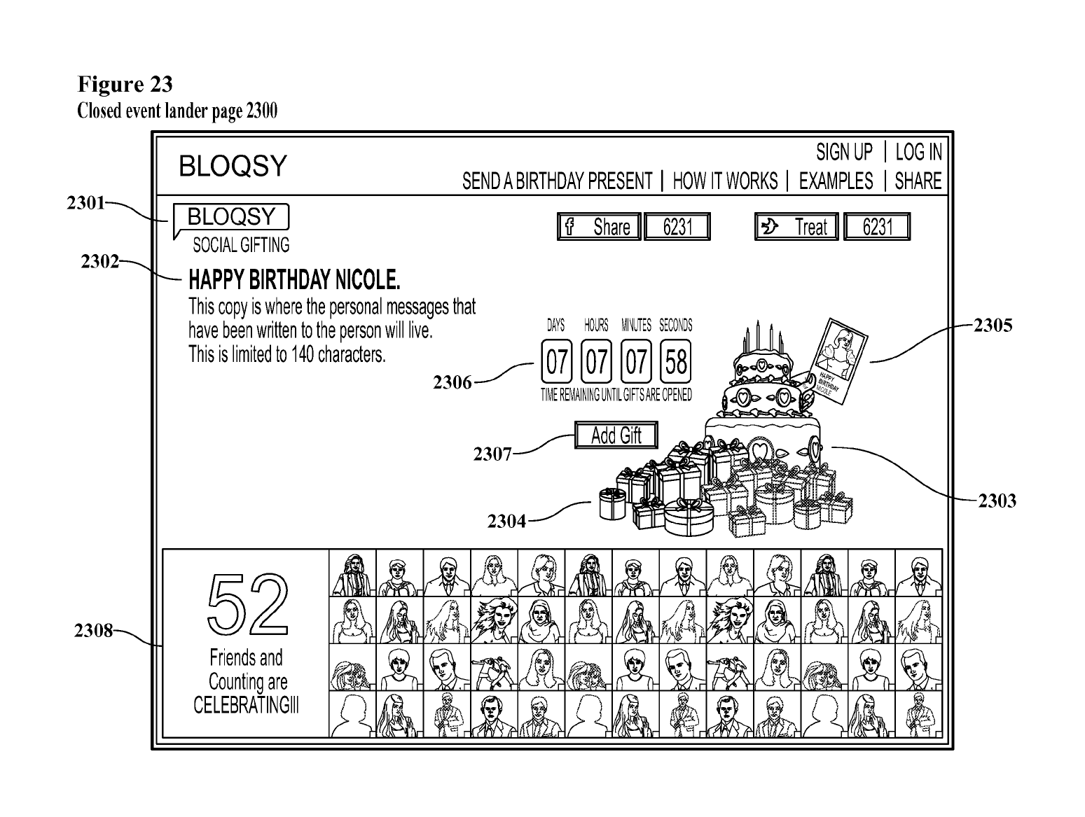

FIG. 23 shows an example of a closed event lander page 2300. The Bloqsy logo 2301 is shown on the top left of the page. Below the logo is a caption 2302 of the event lander page, “Happy Birthday Nicole” in this example. A short greeting is also displayed. The main design is at the center of the page, here a large birthday cake 2303 and a number of gift boxes 2304. A photo of the Recipient 2305 is attached to the birthday cake. A count-down timer 2306 is displayed next to the birthday cake that shows the number of days, hours, minutes, and seconds until the gift can be opened. Below the count down timer is an Add Gift button 2307 Before the gift can be opened, the recipient can mouse-over the gift boxes to preview who has sent a greeting, but the recipient cannot view the greeting message or the gift that was sent. After the count-down timer becomes zero, the gifts can be opened; the Recipient can click on each gift box to view the full greeting including a greeting text, any photos and videos, and any gifts. At the bottom of the closed event lander page is a gift counter pane 2308 including a short text showing the number of people who have added gifts to the event lander page, in this example, “52 Friends and Counting are Celebrating.” The gift counter pane also includes a pictures area that shows a picture icon for each person who has added gifts to the event lander page. The picture icon is taken from the gift sender's Facebook profile picture or other pictures chosen by the gift sender.

When Initiator finishes editing and submits the event lander page, an announcement message is sent to Recipient informing her that an event lander page is created for her. If both Recipient and Initiator have Facebook accounts, the announcement message is automatically posted on Recipient's Facebook homepage stating that Initiator has sent a gift for her birthday. The announcement message is then automatically propagated among the Recipient's friends' Facebook homepages depending on the Facebook settings. Announcement messages may also be sent to Recipient's email address. If Recipient and Initiator both have accounts on Bloqsy website, and they both have a contact list, the Bloqsy website may find the common contacts and suggest Initiator to send invitation messages to their common contacts to invite them to add contents to the event lander page. Initiator may also manually create a list of people to whom he sends the invitation message. The announcement messages and invitation messages may include identification information for the event lander page such as a web link. Thus, another user may reach the event lander page by following a link in an announcement message. Another registered user may independently desire to send a birthday greeting to Recipient, and the event lander website may prompt the other registered user to the event lander page already created by Initiator.

Posting announcement messages regarding greetings and gifts sent on Bloqsy draws analogy to circulating a birthday card in an office. In an office, if no one starts circulating a card, the chance that you will send an individual birthday card to another is low. But if you get a circulating card, the chances are that you will sign it. On Bloqsy and social network websites combination, when friends start seeing that a group gift and greeting is being made for Recipient, the friends are more likely to follow and contribute to the group gift and greeting.

In a further example, suppose that a friend of Recipient on Facebook has read the announcement message on Recipient's Facebook homepage and followed the web link in the announcement message, the friend would be led to the event lander page as shown in FIG. 23. When the friend clicks the “Add Gift” button 2307 on the event lander page, the friend would be asked to sign in or to register. If the friend is a new user to the event lander website, he would register in a process like that previously described for Initiator, and he would be asked to import information from his Facebook and email accounts. The friend would be given the option to create his own event lander page for Recipient or to join the event lander page created by Initiator.

In another scenario, another registered user on Bloqsy independently desires to send Recipient a birthday greeting using Bloqsy. As the other registered user types in Recipient's name, the Bloqsy website would find that an event lander page has already been created for Recipient's birthday. The other registered user is then given the option to create his own event lander page or to view and participate in the event lander page created by Initiator.

Should the friend or the other registered user decide to create his own event lander page for Recipient's birthday, he would go through a similar process as Initiator did. But suppose in this example the friend or other registered user (“Participant” for convenience) decides to join Initiator's page and simply add a gift or greeting message in there, he will go to the event lander page as shown on FIG. 23 and click on the Add Gift button 2307. Participant will be guided to a page as shown on FIG. 21 to input a text message, to upload pictures, and to upload videos. Participant will also be guided to a page as shown on FIG. 22 for an option to add a gift such as a gift card. By default, Participant's greetings and gifts will be “closed” and the Recipient will initially only see a gift box. Participant may be able to preview his greeting message and gift. Suppose here Participant enters only a greeting message and is satisfied with his greeting, Participant submits his greeting to the event lander page. Participant's contribution will show up on the event lander page as one additional gift box in the closed state. Participant's identification icon will also show on the event lander page, for example, Participant's Facebook picture showing on the bottom part of the event lander page.

As Participant submits his birthday greeting to the event lander page, a new announcement message is sent to Recipient. The announcement message may be sent by email and/or may be posted on Recipient's Facebook wall. If Recipient is also a registered user on Bloqsy, the Bloqsy website may scan for common contacts between Recipient and Participant. Participant may be prompted to send invitation messages to their common contacts to invite them to join the event lander page for Recipient. The Bloqsy website will also prompt Participant to input additional recipients to receive the announcement message and to add greetings on the event lander page. The announcement messages and invitation messages may include identification information for the event lander page such as a web link.

When Recipient receives the announcement message and visits the event lander page before the Recipient's birth date, Recipient would see a closed event lander page as shown on FIG. 23. After clicking a link on the page, Recipient would be asked to sign in or to create an account if she does not already have an account. By creating a user account on Bloqsy and importing contact lists, it makes it possible for the Bloqsy website to suggest recipients for announcement messages to a participant or an initiator. After signing up or signing in, Recipient would be able to click or mouse-over the gift boxes to get a preview of each gift box. For example, mousing-over a gift box created by Initiator may show that it is sent by Initiator and contains a picture and a gift, and mousing-over a gift box created by Participant would show that it is sent by Participant and contains a greeting message. But Recipient will not be able to see content of the gift boxes yet because the event lander page is in a closed state before the triggering event, here the birthday.

The capability to mouse-over and preview the gift boxes entices Recipient to check the event lander page before the birthday. On the other hand, having the closed state before the birthday creates anticipation for the recipient. Additionally, having the closed state would encourage more people to contribute to the birthday lander page. For example, even if one feels uneasy to send an individual on-line greeting message or gift to a coworker, one may feel easier to contribute to a group event such as an event lander described in here. Compared to doing nothing, the sender will feel much better because he/she contributed his/her greeting on an event lander, and the Recipient will feel good receiving an additional greeting.

After the triggering event the event lander page turns into open state, and the recipient is able to view the full content of the event lander page. Recipient will be able to view the full content of the event lander on her birthday, including the text messages, the pictures and videos. Recipient will also be able to redeem the gift cards that were sent to her on Bloqsy. The event lander website will help Recipient keep track of all the gift cards sent to her. The event lander page may include convenient features for Recipient to send thank you notes to Initiator, Participant, and various people who contributed to the event lander page. Initiator, Participant and other people who contributed to the event lander page will be able to view the greeting, photo, and video on the event lander page unless a restriction is placed to limit the view privileges.

The Bloqsy website may be used for purposes other than birthday greetings or other greetings, in which multiple parties pool greetings to one party on an event lander page. The Bloqsy website may also be used by one party to make announcement to multiple parties. In certain aspect of the invention, the Bloqsy website may be used to make preannouncements. For example, expecting parents may preannounce the birth of their child on Bloqsy. In this case, the triggering event, the exact date and time of announcement will depend on the birth of the child. The main part of the announcement, the baby picture, is not available until the baby is born. In this case, the expecting parents are the initiators of the event lander page, but they are also the recipients who will receive the gifts and greetings of multiple participants. When the expecting parents create the event lander page, messages will be sent to select recipients informing the expected baby and the event lander page. The recipients may use the event lander page to send greeting messages and gifts to the expecting parents. In this case, a gift registry may be included on the event lander page to facilitate gifting. Again, the participants may be able to send greetings and gifts in closed states that are not viewable by the recipient until the triggering event occurs. In this case, anticipation is created in both the participants and the initiators. The baby announcement event lander page may also be initiated by a grandparent or friend, and the case becomes more like the birthday greeting example recited previously.

In another example, the Bloqsy website may be used to announce the purchase of a new house. In this case, the buyers would initiate an event lander page to make the announcement. Announcement messages will be sent to a number of the buyers' contacts. The recipients of the messages will be able to reach the event lander page by following a link in the announcement message. A recipient may be able to participate in the event lander page after signing in or signing up with the Bloqsy website. The recipient may participate by sending the buyers a closed or open message, send gifts, or simply wait for the open announcement when the purchase is complete.

The announcement may include multiple media including text, gifts, photos, videos, music, and other media. The announcement contents will be locked so the no one can access it until the date and time scheduled or a triggering event takes place. The date and time may be an event chosen by the person who created the Bloqsy web page such as a birthday or other memorable dates that is a fixed date or time.

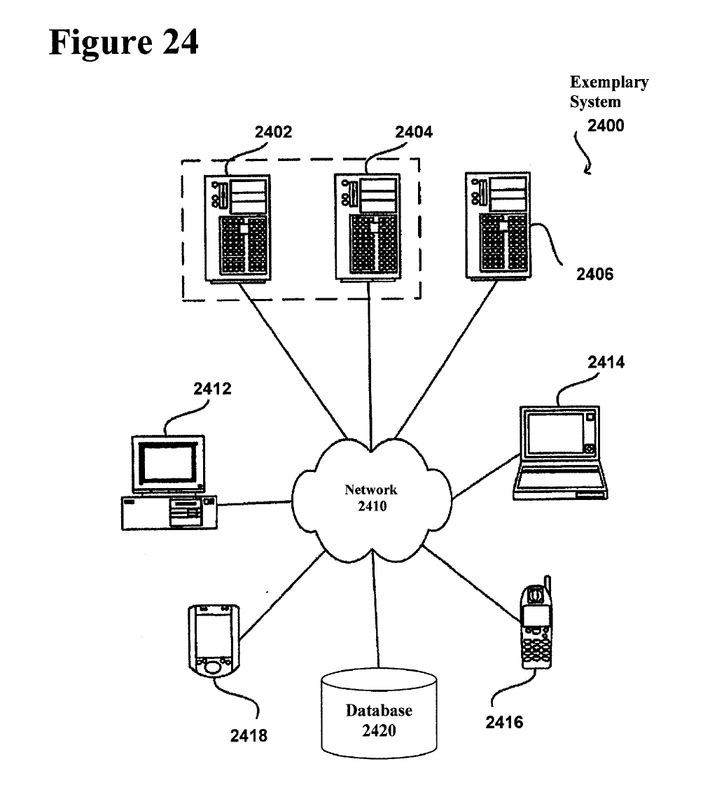

FIG. 24 is a block diagram illustrating components of an exemplary operating environment in which embodiments of the present invention may be implemented. The system 2400 can include one or more user computers, computing devices, or processing devices 2412, 2414, 2416, 2418, which can be used to operate a client, such as a dedicated application, web browser, etc. The user computers 2412, 2414, 2416, 2418 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 2412, 2414, 2416, 2418 may also have any of a variety of applications, including one or more development systems, database client and/or server applications, and Web browser applications. Alternatively, the user computers 2412, 2414, 2416, 2418 may be any other electronic device, such as a thin-client computer, Internet-enabled gaming system, and/or personal messaging device, capable of communicating via a network (e.g., the network 2410 described below) and/or displaying and navigating Web pages or other types of electronic documents. Although the exemplary system 2400 is shown with four user computers, any number of user computers may be supported.

In most embodiments, the system 2400 includes some type of network 2410. The network can be any type of network familiar to those skilled in the art that can support data communications using any of a variety of commercially-available protocols, including without limitation TCP/IP, SNA, IPX, AppleTalk, and the like. Merely by way of example, the network 2410 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 2402, 2404, 2406 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 2406) may be dedicated to running applications, such as a business application, a Web server, application server, etc. Such servers may be used to process requests from user computers 2412, 2414, 2416, 2418. The applications can also include any number of applications for controlling access to resources of the servers 2402, 2404, 2406.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 2412, 2414, 2416, 2418. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 2412, 2414, 2416, 2418.

The system 2400 may also include one or more databases 2420. The database(s) 2420 may reside in a variety of locations. By way of example, a database 2420 may reside on a storage medium local to (and/or resident in) one or more of the computers 2402, 2404, 2406, 2412, 2414, 2416, 2418. Alternatively, it may be remote from any or all of the computers 2402, 2404, 2406, 2412, 2414, 2416, 2418, and/or in communication (e.g., via the network 2410) with one or more of these. In a particular set of embodiments, the database 2420 may reside in a storage-area network (“SAN”) familiar to those skilled in the art. Similarly, any necessary files for performing the functions attributed to the computers 2402, 2404, 2406, 2412, 2414, 2416, 2418 may be stored locally on the respective computer and/or remotely, as appropriate. In one set of embodiments, the database 2420 may be a relational database, such as Oracle 10g, that is adapted to store, update, and retrieve data in response to SQL-formatted commands.

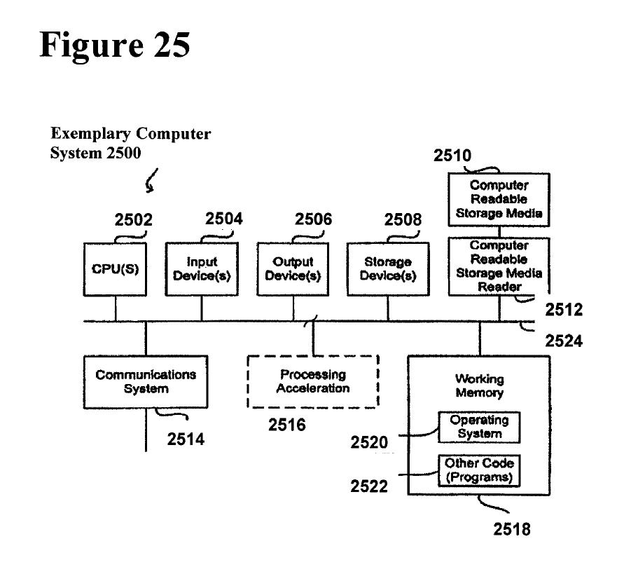

FIG. 25 illustrates an exemplary computer system 2500, in which embodiments of the present invention may be implemented. The system 2500 may be used to implement any of the computer systems described above. The computer system 2500 is shown comprising hardware elements that may be electrically coupled via a bus 2524. The hardware elements may include one or more central processing units (CPUs) 2502, one or more input devices 2504 (e.g., a mouse, a keyboard, etc.), and one or more output devices 2506 (e.g., a display device, a printer, etc.). The computer system 2500 may also include one or more storage devices 2508. By way of example, the storage device(s) 2508 can include devices such as disk drives, optical storage devices, solid-state storage device such as a random access memory (“RAM”) and/or a read-only memory (“ROM”), which can be programmable, flash-updateable and/or the like.

The computer system 2500 may additionally include a computer-readable storage media reader 2512, a communications system 2514 (e.g., a modem, a network card (wireless or wired), an infra-red communication device, etc.), and working memory 2518, which may include RAM and ROM devices as described above. In some embodiments, the computer system 2500 may also include a processing acceleration unit 2516, which can include a digital signal processor DSP, a special-purpose processor, and/or the like.

The computer-readable storage media reader 2512 can further be connected to a computer-readable storage medium 2510, together (and, optionally, in combination with storage device(s) 2508) comprehensively representing remote, local, fixed, and/or removable storage devices plus storage media for temporarily and/or more permanently containing, storing, transmitting, and retrieving computer-readable information. The communications system 2514 may permit data to be exchanged with the network and/or any other computer described above with respect to the system 2500.

The computer system 2500 may also comprise software elements, shown as being currently located within a working memory 2518, including an operating system 2520 and/or other code 2522, such as an application program (which may be a client application, Web browser, mid-tier application, RDBMS, etc.). It should be appreciated that alternate embodiments of a computer system 2500 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 25 further illustrates an environment where an on-demand distributed database service might be used. As illustrated in FIG. 25 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

The above illustrations provide many different embodiments for implementing different features of the invention. Specific embodiments of components and processes are described to help clarify the invention. These are, of course, merely embodiments and are not intended to limit the invention from that described in the claims.

An exemplary application platform peer to peer network includes an application setup mechanism that supports application developers' creation and management of applications, which may be saved as metadata into a database by save routines for execution by subscribers as one or more processes managed by distributed database management processes for example. Invocations to such applications may be coded using PL/SOQL that provides a programming language style interface extension to an application programming interface API or other suitable programming languages. Invocations to applications may be detected by one or more system processes which manage retrieval of application metadata for the subscriber making the invocation and executing the metadata as an application in a virtual machine.

It should also be understood that each application server may be communicably coupled to one or more distributed database systems, e.g., system database and multi-enterprise database(s), via a different network connection to form a peer to peer network. For example, one server might be coupled via the Internet, another server might be coupled via a direct network link, and another server might be coupled by yet a different network connection. Transfer Control Protocol and Internet Protocol (TCP/IP) are typical protocols for communicating between servers and one or more distributed database systems. However, it will be apparent to one skilled in the art that other transport protocols may be used to optimize the system depending on the network interconnect used to implement the peer to peer, distributed network.

Each of the one or more distributed database systems can generally be viewed as a collection of objects, such as a set of logical tables, containing data fitted into predefined categories. A “table” is one representation of a data object, and is used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields.

What is claimed is:

1. A method for providing a social gifting system, comprising the following steps:
creating a predefined event date and an associated first greeting message to a recipient,
assembling an event icon to visualize the associated subsequent greeting messages with one or more gifts from one or more gift greeting friends,
displaying the event icon and one or more gifts in an event lander page view,
appending a gift greeting grid to a gift counter to aggregate one or more gift greeting friend photos.

2. The method of claim 1 wherein the one or more gifts in an event lander page view comprise one or more gift groups, said gift groups selected from the group consisting of gift group 1/five packages in a single row, gift group 2/13×2 packages comprising thirteen packages in two rows, gift group 3/15×2 packages comprising fifteen packages in two rows, and gift group 4/4×2 packages comprising four packages in two rows.

3. The method of claim 1 wherein the one or more gifts may be redeemed from one or more participating vendors in one or more categories.

4. The method of claim 1, further comprising:
associating the one or more gifts with a related gift greeting photo through the use of a friend finder tool.

5. The method of claim 1 wherein the event icon is a birthday cake.

6. The method of claim 1 wherein the social gifting system is a gift registry and wherein an event announcement and a desired gift list is displayed for one or more gift greeter friends.

7. The method of claim 6, further comprising steps for updating the desired gift list to reflect the selected gifts by one more gift greeter friends to display an updated inventory of desired gifts in the desired gift list.

8. The method of claim 6 wherein the event announcement is associated with a news message.

9. A computer implemented method of social gifting, comprising:
providing a means for a user to register as a registered user, wherein said registered user has access to a digital device for viewing a web page;
providing a means for a first registered user to create a database of one or more friends;
providing an interface for said first registered user to select a recipient; wherein said interface comprising program code to be delivered to said first registered user's digital device for displaying a select-your-friend web page, said select-your-friend web page allowing said first registered user to select a recipient from a list displayed on the web page; wherein said interface comprising program code to be delivered to said first registered user's digital device for displaying a select-your-friend page, said select-your-friend page allowing said first registered user to search for a friend from a database of friends and to select a recipient from a search result list;
providing an interface for said first registered user to select an event and a template for creating an event lander page for said event;
providing an interface for said first registered user to create a greeting for said event to be delivered with said event lander, said greeting comprising one or more items selected from the group consisting of a message, a picture, a video, and a gift card; wherein said gift card comprises a proprietary gift card, said proprietary gift card can be redeemed by said recipient to buy vendor gift cards;
providing a means for delivering said event lander page through a web browser over a network, said event lander page displaying said greeting, part of the content of said greeting being locked until a release date, said event lander page comprising an add-gift button;
providing a means for said first registered user to designate part of his greeting as private content that cannot be displayed on the event lander page after said release date; wherein said add-gift button in blocked to said recipient such that the recipient cannot add gift to itself;
sending a message to said recipient, said message comprising a link to said event lander page; wherein said message is posted on said recipient's social network webpage wall;
locking said event lander page;
sending a message to one or more friends of said recipient;
unlocking said event lander page after said release date so that the recipient can view the full content of the greeting;
providing a mechanism for said recipient to restrict the viewing of part of said greeting to said recipient only;
sending said greeting to said recipient via internet for displaying on said recipient's electronic device, after said release date;
unlocking said event lander page after said release date and enabling said recipient to redeem gift cards sent through said event lander page; and
enabling said recipient to combine gift cards.

10. The method of claim 9, further comprising:
providing a registered second user through an interface;
providing a means for said second user to select said event lander page and to add a second greeting on said event lander page, said greeting comprising one or more items selected from the group consisting of a message, a picture, a video, and a gift card; wherein said gift card comprises a proprietary gift card, said proprietary gift card can be redeemed by said recipient to buy vendor gift cards, wherein said second greeting comprises participant content associated with one or more privacy privilege status identifiers, wherein said privacy privilege status identifiers are selected from the group consisting of public participant content, confidential content, and optionally private content;
associating said second greeting with said second user, locking said second greeting so that said confidential content and said private content of said second greeting can only be viewed by said second user;
sending a second message to said recipient, said message comprising a link to said event lander page; wherein said message may be posted on said recipient's Facebook wall to notify said recipient that said second user has posted a greeting on said event lander page; and
sending a message to one or more friends of said recipient.
